(19) United States
(12) Patent Application Publication
(10) Pub. No.: US 2017/0140481 A1
(43) Pub. Date: May 18, 2017

(54) ELECTRIC POWER PROCUREMENT ADJUSTMENT APPARATUS AND ELECTRIC POWER PROCUREMENT ADJUSTMENT METHOD

(71) Applicant: FUJITSU LIMITED, Kawasaki-shi (JP)

(72) Inventors: Tsuyoshi TANIGUCHI, Kawasaki (JP); Yoshio Nakao, Kawasaki (JP)

(73) Assignee: FUJITSU LIMITED, Kawasaki-shi (JP)

(21) Appl. No.: 15/347,121

(22) Filed: Nov. 9, 2016

(30) Foreign Application Priority Data
Nov. 12, 2015 (JP) 2015-222508

(51) Int. Cl. G06Q 50/06; G06Q 10/06

(52) U.S. Cl. CPC G06Q 50/06; G06Q 10/06315

(57) ABSTRACT

A non-transitory computer-readable recording medium stores an electric power procurement adjustment program that causes a computer to execute a process. The process includes generating applicable time-series data items by excluding procurement time-series data items indicating a large total procurement amount from procurement time-series data items defining a power amount to be procured from outside at every predetermined time; generating reference procurement time-series data to be used as a reference of adjustment, based on an expectation value in each time period in the applicable time-series data items; and comparing the applicable time-series data items with the reference procurement time-series data, extracting an applicable time-series data item having a larger total procurement amount than that of the reference procurement time-series data, and generating procurement adjustment time-series data, which is a target of the adjustment, based on the extracted applicable time-series data item.

### CROSS-REFERENCE TO RELATED APPLICATION

This patent application is based upon and claims the benefit of priority of the prior Japanese Patent Application No. 2015-222508 filed on Nov. 12, 2015, the entire contents of which are incorporated herein by reference.

### FIELD

The embodiments discussed herein are related to an electric power procurement adjustment apparatus and an electric power procurement adjustment method (hereinafter, electric power may be simply referred to as “power”).

### BACKGROUND

Solar power generation is environmentally advantageous because greenhouse gas is not emitted at the time of power generation. Solar power generation is also advantageous in terms of cost, because the cost is being decreased to a profitable level. However, the solar power generation amount changes according to the weather. Therefore, in order to utilize solar power generation in an electricity retailing business that requires stable power supply, systematic operations based on power generation forecasts are needed. The systematic operations include a combination of electric power supply sources including stable power suppliers based on contracts such as electric utility companies, installation of equipment such as storage batteries, and the power market. Furthermore, there are relatively high errors in the forecast of solar power generation, and there are output variations that are difficult to forecast. Therefore, there is a need for a means to compensate for the excess or deficiency in the power generation amount with respect to the planned value. For example, by using storage batteries, it is possible to discharge electric power when there is a deficiency in the power generation amount, and to charge the storage batteries with electric power when there is an excess in the power generation amount. However, there is a limit in the power that may charge or be discharged by the storage battery per unit time, and there is a limit in the power storage amount that may be used per unit time. Therefore, it is not possible to supply an amount of power that exceeds the equipment restriction. In a case where the impact of the forecast error exceeds the capacity of the installed equipment, and a cost corresponding to a penalty may arise for procuring electric power that exceeds the contracted power from the stable power supplier, it is possible to suppress the increase in cost. Specifically, the increase in the cost may be suppressed by procuring electric power on the preceding day (preliminary procurement) from the power market to secure backup power and to be prepared for the forecast error.

In retailing businesses of electricity including solar power generation, it is often the case that the amount of power supply from the respective power supply sources is scheduled based on solar power generation forecasts and demand forecasts. Many studies are made with respect to demand forecasts and solar power generation forecasts. The research results may be used to create an operation plan.

Solar power generation forecasts and demand forecasts include errors, and when an error occurs, unplanned excesses and deficiencies will arise in the power supply. Accordingly, there is a method of creating a forecast error distribution based on past data, and applying this distribution to cost evaluations (see, for example, Patent Document 1, etc.). That is, when determining the target value of output per unit time (one hour), according to which power system comprising natural energy and output compensation devices should supply power, the forecast error distribution is created based on past forecast performance values and output performance values. This forecast error distribution is used to consider the penalty concerning an excess or a deficiency with respect to the amount of power supply (target value) submitted in advance to the electric utility company, which would arise when the power generation forecast error is too large for the storage battery to compensate.

In the following, time-series forecast (observation) data is referred to as a scenario. Specifically, the time-series forecast (observation) data is, for example, the power demand variation or the solar power generation variation, etc., of a certain day. The procedure for calculating the probability of the forecast data being realized, is defined. In order to consider the impact of the forecast error, there is a method of generating the variation in the demand as probabilistic scenarios based of past data, and selecting the operation plan having a high expectation value in the effect with respect to all scenarios, from among the operation plans optimized for the respective scenarios (see, for example, Non-patent Document 1, etc.). That is, a set of probabilistic demand scenarios, i.e., a model of the demand variation, are generated by using a variance-covariance matrix based on past load curve data, and for each demand scenario, an optimal generation schedule is calculated by using a conventional optimization method concerning unit commitment scheduling and economic load dispatching. Then, from among those schedules, the power generation schedule having the lowest power generation cost is selected as the optimal power generation schedule.

Patent Document 1: Japanese Laid-Open Patent Publication No. 2008-54385

Non-patent Document 1: “Optimal generator scheduling using probabilistic demand scenarios”, Journal of The Institute of Electrical Engineers of Japan B.131, 3, pp 271-276 (2011)

As described above, forecasts of the power consumption amount entail errors. Therefore, in the conventional technology, it is difficult to obtain the optimum amount of electric power to be procured on the preceding day, within a sufficiently short time such that the calculation is completed before the deadline for determining the electric power to be procured on the preceding day, while complying with the following three restrictions.

(1) The supplied power is less than or equal to the contracted power of an electric utility company.
(2) The power is less than or equal to the discharge restriction per unit time of a storage battery.
(3) The accumulative discharge amount of the storage battery is less than or equal to the capacity restriction of the storage battery.

A procurement plan may be created, in which the number of variables is reduced by using statistic data (an average value, etc.) as the forecast error per unit time, instead of using the forecast errors of the respective scenarios. However, in this case, the storage battery is not sufficiently controlled, and the capacity restriction might not be satisfied.

When the procurement plan is created by solving the optimization problem based on the restriction condition with respect to the storage battery for only a particular scenario, if another scenario is realized, the restriction condition might not be satisfied.

When the solution of an optimization problem is obtained, in which restriction conditions are set with respect to the discharge restriction and the capacity restriction of the storage battery in each time period for all scenarios, and a procurement plan is created based on the solution, a large number of variables will be handled, and the calculation time will increase.

### SUMMARY

According to an aspect of the embodiments, a non-transitory computer-readable recording medium stores an electric power procurement adjustment program that causes a computer to execute a process, the process including generating a plurality of applicable time-series data items by excluding procurement time-series data items indicating a large total procurement amount from a plurality of procurement time-series data items defining a power amount to be procured from outside at every predetermined time; generating reference procurement time-series data to be used as a reference of adjustment, based on an expectation value in each time period in the plurality of applicable time-series data items; and comparing the plurality of applicable time-series data items with the reference procurement time-series data, extracting one or more of the plurality of applicable time-series data items having a larger total procurement amount than a total procurement amount of the reference procurement time-series data, and generating procurement adjustment time-series data, which is a target of the adjustment, based on the extracted one or more of the plurality of applicable time-series data items.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating an example of a configuration of a system according to an embodiment;

FIG. 2 is a detailed diagram of a procurement plan creating system;

FIG. 3 is a diagram illustrating an example of a hardware configuration of a procurement plan creating apparatus constituting the procurement plan creating system;

FIG. 4 is a flowchart illustrating an example of a process by a reference procurement plan creating unit;

FIG. 5 is a diagram illustrating an example of the extraction of the solar power generation observation data;

FIG. 6 is a diagram illustrating an example of the calculation of the net demand;

FIG. 7 is a flowchart illustrating an example of a process of generating a procurement scenario;

FIG. 8 is a diagram illustrating an example of the calculation of a contracted power exceeding scenario;

FIGS. 9A and 9B are diagrams illustrating examples of equipment restriction data used in demand adjustment;

FIG. 10 is a diagram illustrating an example of the calculation of a power storage amount allocation scenario;

FIG. 11 is a diagram illustrating an example of the calculation of a procurement scenario;

FIG. 12 is a diagram illustrating an example of extraction of applicable scenarios;

FIG. 13 is a diagram illustrating an example of the calculation of a reference procurement scenario;

FIG. 14 is a diagram illustrating the extraction of a procurement adjustment scenario;

FIG. 15 is a flowchart illustrating an example of a process by a reference procurement plan adjusting unit;

FIGS. 16A and 16B are diagrams illustrating examples of data formats of a discharge-restriction-response procurement scenario and a capacity-restriction-response procurement scenario;

FIG. 17 is a flowchart illustrating an example of a procurement adjustment time period extracting process;

FIG. 18 is a diagram illustrating an example of updating the procurement adjustment scenario;

FIG. 19 is a diagram illustrating the extraction of the procurement adjustment time periods;

FIG. 20 is a flowchart illustrating an example of a discharge-restriction-response procurement updating process;

FIG. 21 is a diagram illustrating an example of the calculation of the discharge-restriction-response procurement;

FIG. 22 is a diagram illustrating an example of the updating of the discharge-restriction-response procurement;

FIG. 23 is a diagram illustrating an example of the calculation of the procurement after responding to the discharge restriction;

FIG. 24 is a flowchart illustrating an example of a capacity-restriction-response procurement updating process (part 1);

FIG. 25 is a flowchart illustrating an example of a capacity-restriction-response procurement updating process (part 1);

FIG. 26 is a diagram illustrating an example of the evaluation of the capacity restriction violation;

FIG. 27 is a diagram illustrating an example of the calculation of the minimum value and the average value of contracted power exceeding amounts in each unit time;

FIG. 28 is a diagram illustrating an example of the updating of the capacity-restriction-response procurement;

FIG. 29 is a diagram illustrating an example of the calculation of the procurement after responding to the capacity restriction;

FIG. 30 is a diagram of an example of the updating of the capacity-restriction-response procurement (part 1);

FIG. 31 is a diagram of an example of the updating of the capacity-restriction-response procurement (part 2);

FIG. 32 is a diagram of an example of the updating of the capacity-restriction-response procurement (part 3);

FIG. 33 is a diagram of an example of the updating of the capacity-restriction-response procurement (part 4); and

FIG. 34 is a diagram illustrating an example of a procurement plan.

### DESCRIPTION OF EMBODIMENTS

Preferred embodiments of the present invention will be explained with reference to accompanying drawings.

### <Configuration>

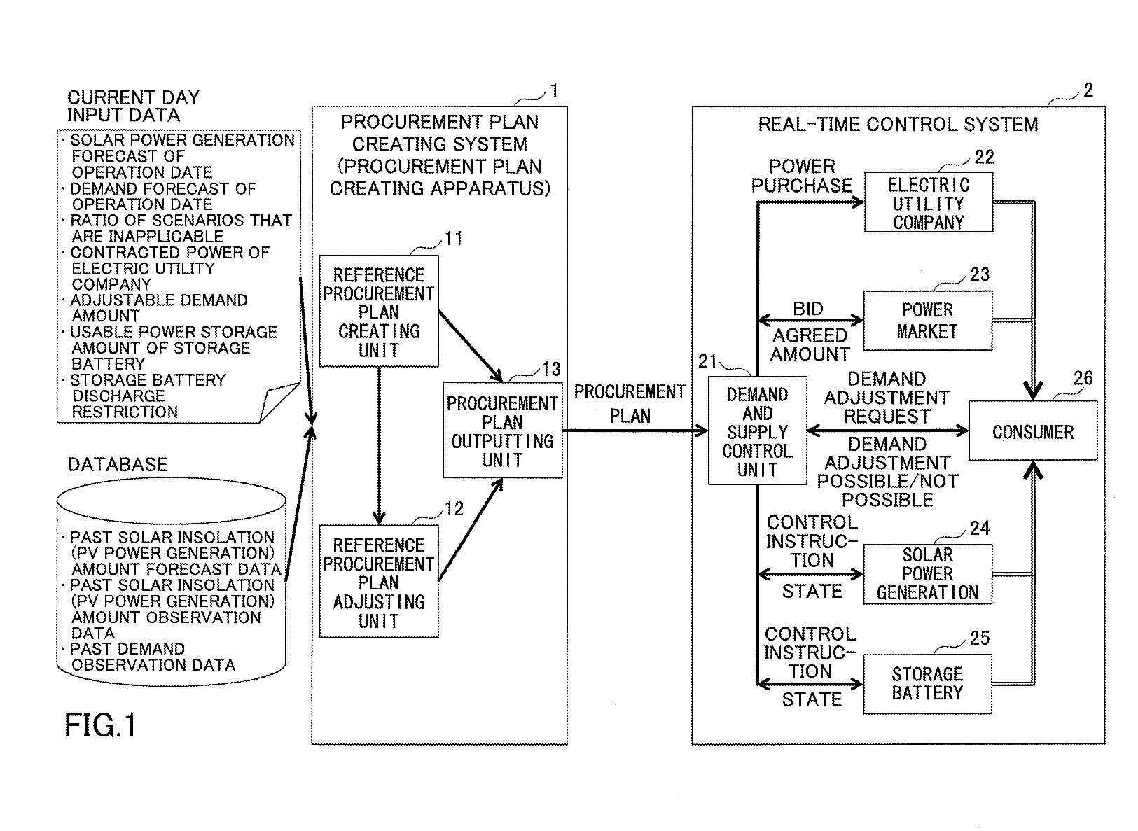

FIG. 1 is a diagram illustrating an example of a configuration of a system according to an embodiment. In FIG. 1, a procurement plan creating system 1 and a real-time control system 2 are provided. The procurement plan creating system 1 creates and outputs a procurement plan (preceding day procurement plan) in consideration of the forecast error in the solar power generation based on data input on the current day (current day input data) and data in a database. The real-time control system 2 controls the power supply in a real-time manner based on the procurement plan. That is, the procurement plan creating system 1 creates a procurement plan in consideration of the power generation forecast error of solar power generation. A demand and supply control unit 21 of the real-time control system 2 controls the respective supply sources. Particularly, the demand and supply control unit 21 controls the procurement amount from a power market 23 based on the procurement plan created by the procurement plan creating system 1. Note that the solid lines with arrows indicate the flow of data (information), and the double lines with arrows indicate the flow of electricity.

The procurement plan creating system 1 includes a reference procurement plan creating unit 11, a reference procurement plan adjusting unit 12, and a procurement plan outputting unit 13. The current day input data used by the procurement plan creating system 1 includes the following information.
Solar power generation forecast of an operation date
Demand forecast of an operation date
Ratio of scenarios that are inapplicable
Contracted power of an electric utility company
Adjustable demand amount
Usable power storage amount of the storage battery
Discharge restriction of the storage battery Furthermore, the database includes the following information.
Past solar insolation (PV (Photovoltaic) power generation) amount forecast data
Past solar insolation (PV power generation) amount observation data
Past demand observation data

In the real-time control system 2, power is supplied by solar power generation 24 and from an electric utility company 22, as the major supply sources supplying power to a consumer 26. Furthermore, a storage battery 25, the power market 23, and demand adjustment are used as means for compensating for the forecast error in the solar power generation 24.

The solar power generation 24 is used as a power supply source that is environmentally advantageous but has unstable output. The solar power generation 24 basically supplies all of the generated power to the consumer 26 without selling electric power.

The electric utility company 22 supplies power of a relatively large scale, which is purchased by the electricity retailer collectively in place of small consumers to reduce the power supplying cost. Specifically, the electric utility company 22 supplies power to the consumers, by a meter-rate price (with respect to large-scale consumers) that depends on the amount of the contracted power (upper limit), and the power is used when the solar power generation cannot generate enough power for consumers' demands.

The power market 23 supplements the solar-generated power, and is used as a procurement source of power, for preventing the power supplied by the electric utility company 22 from reaching the upper limit, i.e., the contracted power. In the power market 23, a bid for the necessary power amount is tendered by a predetermined bidding time, and the agreed power amount is procured from the power market 23. In the power market 23, referring to JEPX (Japan Electric Power Exchange), the product corresponds to 24 hours divided in units of 30 minutes. In the spot market, a bid is tendered by 9:30 on the preceding day of the delivery date. In an hour-ahead market, in the first part (13:00 to 17:00), a bid is tendered by 9:00 on the delivery date. In the second part (17:00 to 21:00) of the hour-ahead market, a bid is tendered by 13:00 on the delivery date. In the third part (21:00 to 13:00 on the next day) of the hour-ahead market, a bid is tendered by 17:00 on the delivery date.

The storage battery 25 is used as a means for responding to a forecast error in solar power generation. When there is a deficiency in the necessary power as a result of supplying power by solar power generation 24 and from the power market 23, the storage battery 25 supplies power to the consumer 26 within the range of the charging and discharging restrictions. Specifically, when power is supplied by solar power generation 24 and from the power market 23, but there is still a need for power exceeding the contracted power from the electric utility company 22, the storage battery 25 discharges power corresponding to the excessive amount of power that is needed.

When it is not possible to obtain the solar power generation amount that has been estimated at the time of forecast, the demand is adjusted. Alternatively, the demand is adjusted in a case where the demand exceeds the estimated demand, and even by procuring power from the power market 23 and using the storage battery 25, there is a need to supply power exceeding the contracted power from the electric utility company 22.

There may be cases where it is necessary to supply power exceeding the contracted power of the electric utility company 22, even after supplying power from all of the above supply sources. In this case, a load variation range exceeding power fee, which is several times higher than the regular fee, is paid to the electric utility company 22 to supply the necessary power to the consumer 26.

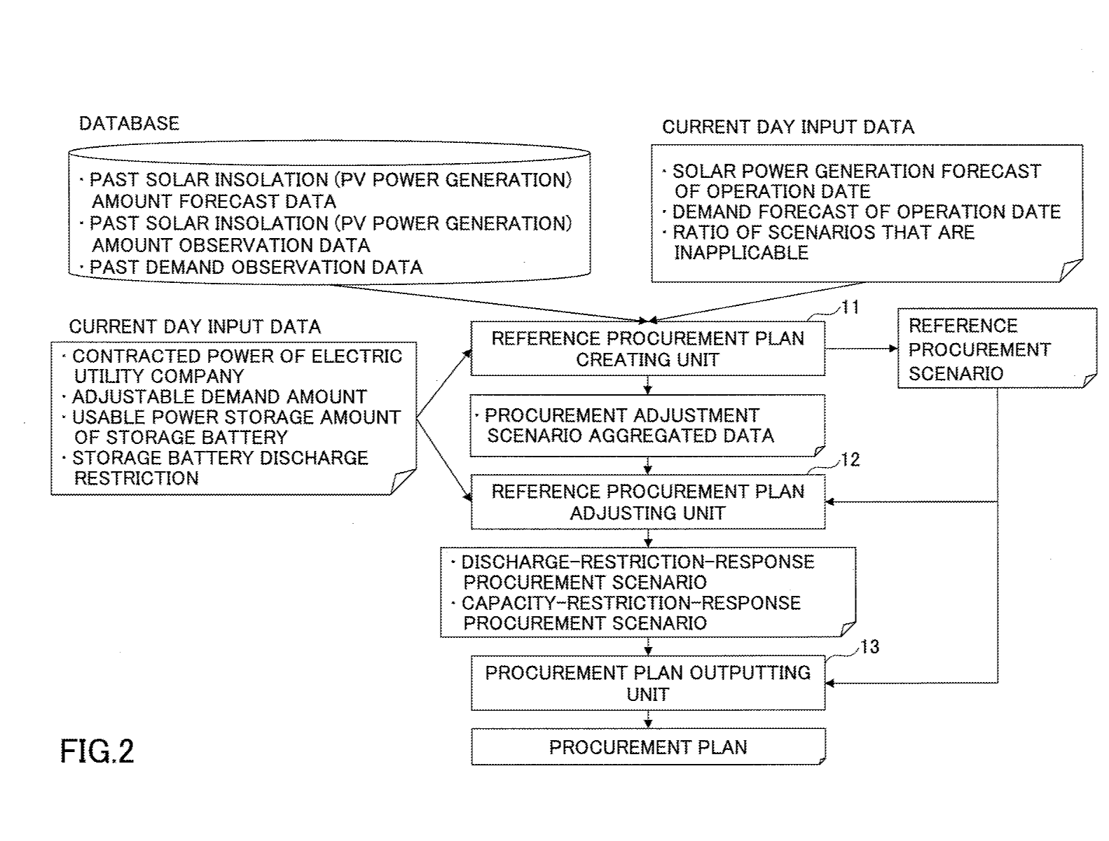

FIG. 2 is a detailed diagram of the procurement plan creating system 1. As described above, the procurement plan creating system 1 includes the reference procurement plan creating unit 11, the reference procurement plan adjusting unit 12, and the procurement plan outputting unit 13.

The reference procurement plan creating unit 11 receives input of the solar power generation forecast and the demand forecast of the operation date, the ratio of scenarios that are inapplicable, the past solar insolation (PV power generation) amount forecast data, the past solar insolation (PV power generation) amount observation data, the past demand observation data, the contracted power of an electric utility company, the adjustable demand amount, the usable power storage amount of the storage battery, and the storage battery discharge restriction. Furthermore, the reference procurement plan creating unit 11 outputs a reference procurement scenario and procurement adjustment scenario aggregated data. The reference procurement scenario expresses the expected procurement amount values in units of time periods for each of the time periods, when the utilization of the storage battery and demand adjustment are maximized. The procurement adjustment scenario aggregated data expresses the deficiency in the procurement amount that arises when power is procured according to the reference procurement scenario.

The reference procurement plan adjusting unit 12 receives input of the contracted power of an electric utility company, the adjustable demand amount, the usable power storage amount of the storage battery, the storage battery discharge restriction, and the reference procurement scenario and the procurement adjustment scenario aggregated data that are output from the reference procurement plan creating unit 11. Furthermore, the reference procurement plan adjusting unit 12 outputs a discharge-restriction-response procurement scenario and a capacity-restriction-response procurement scenario, for compensating for the deficiency in the procurement that arises when power is procured only from the power market according to the reference procurement scenario.

The procurement plan outputting unit 13 receives input of the reference procurement scenario, the discharge-restriction-response procurement scenario, and the capacity-restriction-response procurement scenario. Furthermore, the procurement plan outputting unit 13 outputs a procurement plan.

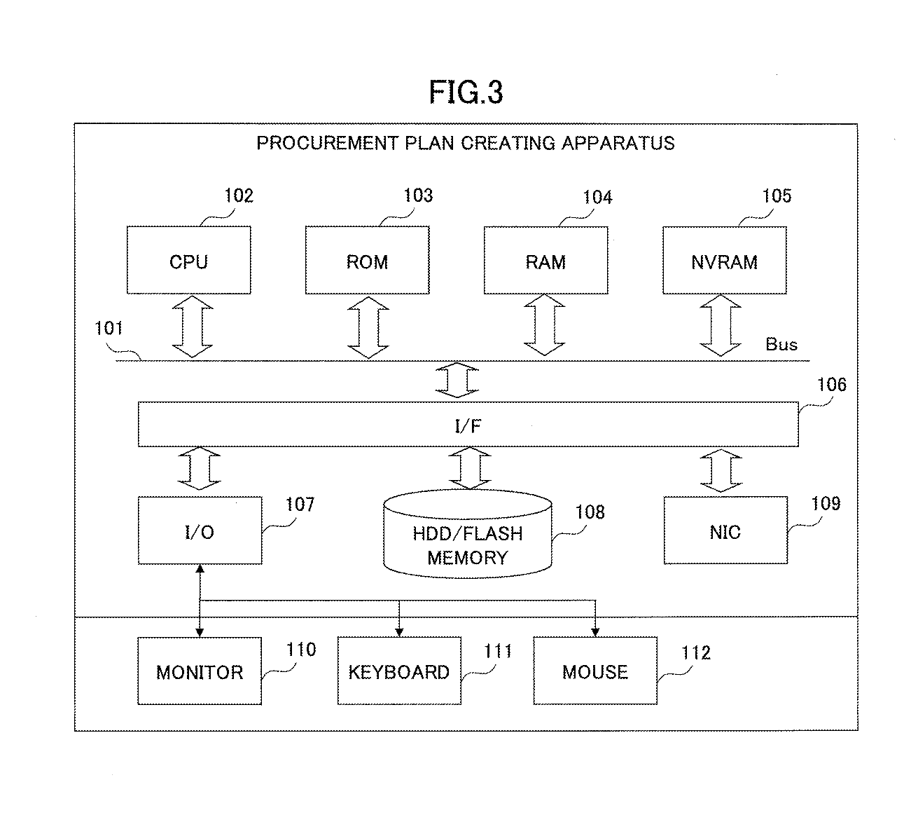

FIG. 3 is a diagram illustrating an example of a hardware configuration of a procurement plan creating apparatus constituting the procurement plan creating system 1. In FIG. 3, the procurement plan creating apparatus includes a CPU (Central Processing Unit) 102, a ROM (Read-Only Memory) 103, a RAM (Random Access Memory) 104, and a NVRAM (Non-Volatile Random Access Memory) 105, which are connected to a system bus 101. Furthermore, the procurement plan creating apparatus includes an I/F (Interface) 106 connected to the system bus 101. Furthermore, the procurement plan creating apparatus includes an I/O (Input/Output Device) 107, a HDD (Hard Disk Drive)/flash memory 108, and a NIC (Network Interface Card) 109, which are connected to the I/F 106. Furthermore, the procurement plan creating apparatus includes a monitor 110, a keyboard 111, and a mouse 112, etc., which are connected to the I/O 107. To the I/O 107, a CD/DVD (Compact Disk/Digital Versatile Disk) drive, etc., may be connected.

The functions of the procurement plan creating system 1 described with reference to FIGS. 1 and 2 are realized as a predetermined program is executed by the CPU 102. The program may be acquired via a recording medium, or may be acquired via a network, or may be incorporated in the ROM.

### <Operations>

In the following, details of the operations of the respective processing units are described.

### [Reference Procurement Plan Creating Unit 11]

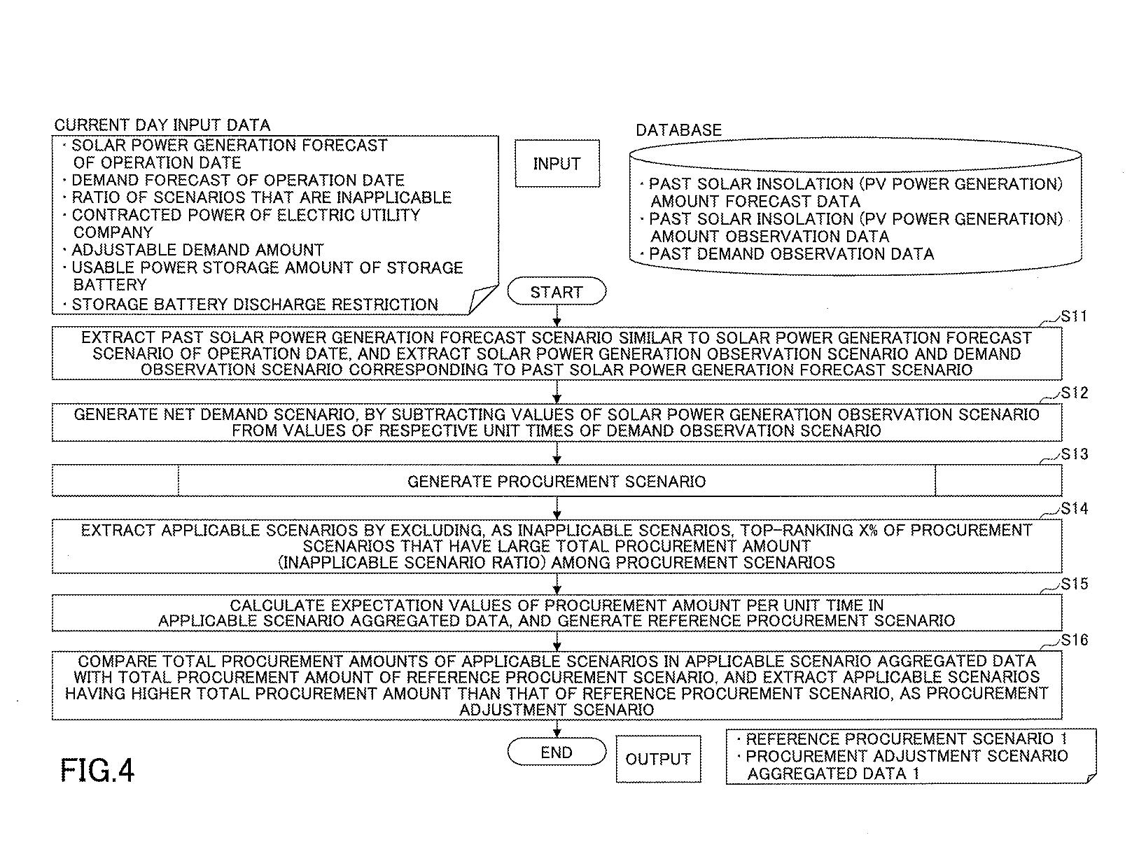

FIG. 4 is a flowchart illustrating an example of a process by the reference procurement plan creating unit 11. The reference procurement plan creating unit 11 receives input of the solar power generation forecast of the operation date, the demand forecast of the operation date, the past solar insolation (PV power generation) amount forecast data, the past solar insolation (PV power generation) amount observation data, the past demand observation data, the contracted power of an electric utility company, the inapplicable scenario ratio, the adjustable demand amount, the usable power storage amount of the storage battery, and the storage battery discharge restriction. Furthermore, the reference procurement plan creating unit 11 outputs a reference procurement scenario and procurement adjustment scenario aggregated data.

In FIG. 4, first, the reference procurement plan creating unit 11 extracts a past solar power generation forecast scenario similar to the solar power generation forecast scenario of the operation date, and extracts a solar power generation observation scenario and a demand observation scenario corresponding to the past solar power generation forecast scenario (step S11).

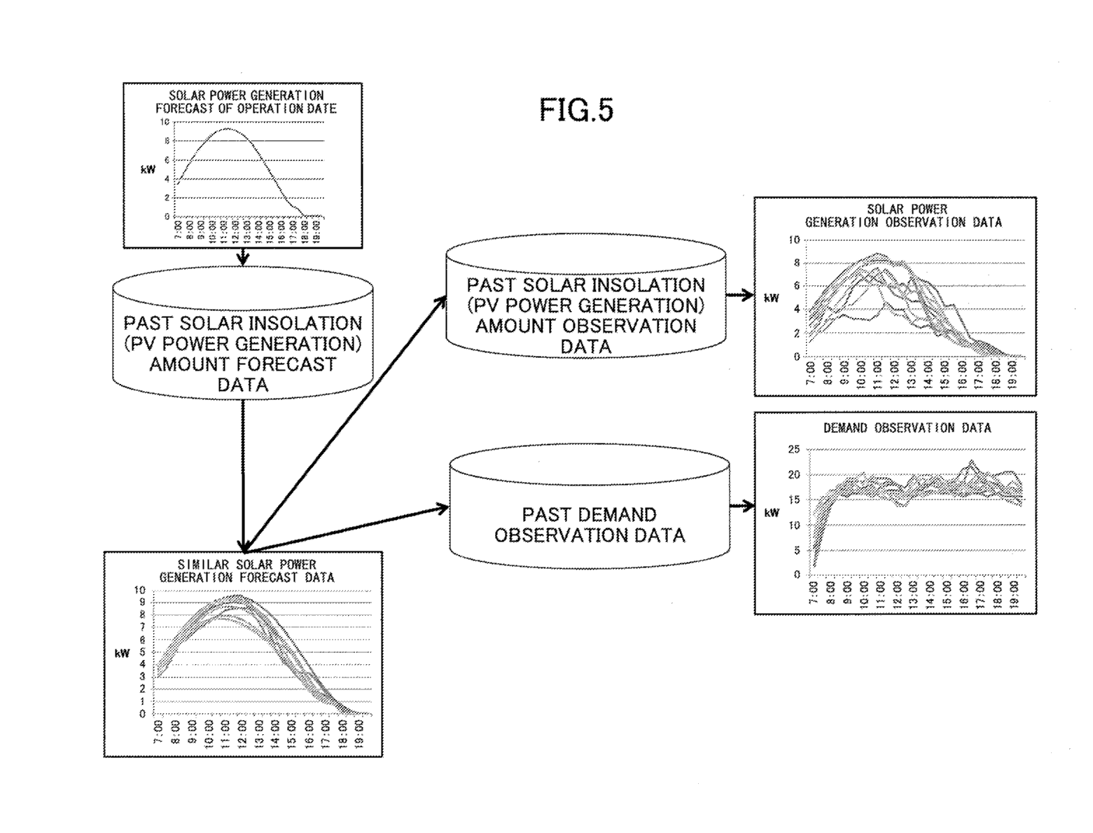

FIG. 5 is a diagram illustrating an example of the extraction of the solar power generation observation data. First, the solar power generation forecast of the current operation date is input. Here, it is assumed that the solar power generation amount is forecast by some kind of forecast method. Solar power generation forecast data, which is similar to the input solar power generation forecast, is extracted from past data. Here, in the extracted solar power generation forecast data, the differences in the power generation amounts of the respective time periods in the input solar power generation forecast and the total power generation amount are within thresholds that have been set. The solar power generation observation data, which is the performance with respect to the extracted solar power generation forecast, is extracted. The extracted solar power generation observation data is considered to be the solar power generation observation data that may occur with respect to the input solar power generation forecast. The impact of the forecast error is evaluated based on a plurality of solar power generation observation data items that have been extracted as described above. Furthermore, demand observation data, which is associated with the solar power generation observation data by a date, etc., is extracted. When there is no demand observation data that is associated with the solar power generation observation data, demand forecast data is associated with the solar power generation observation data.

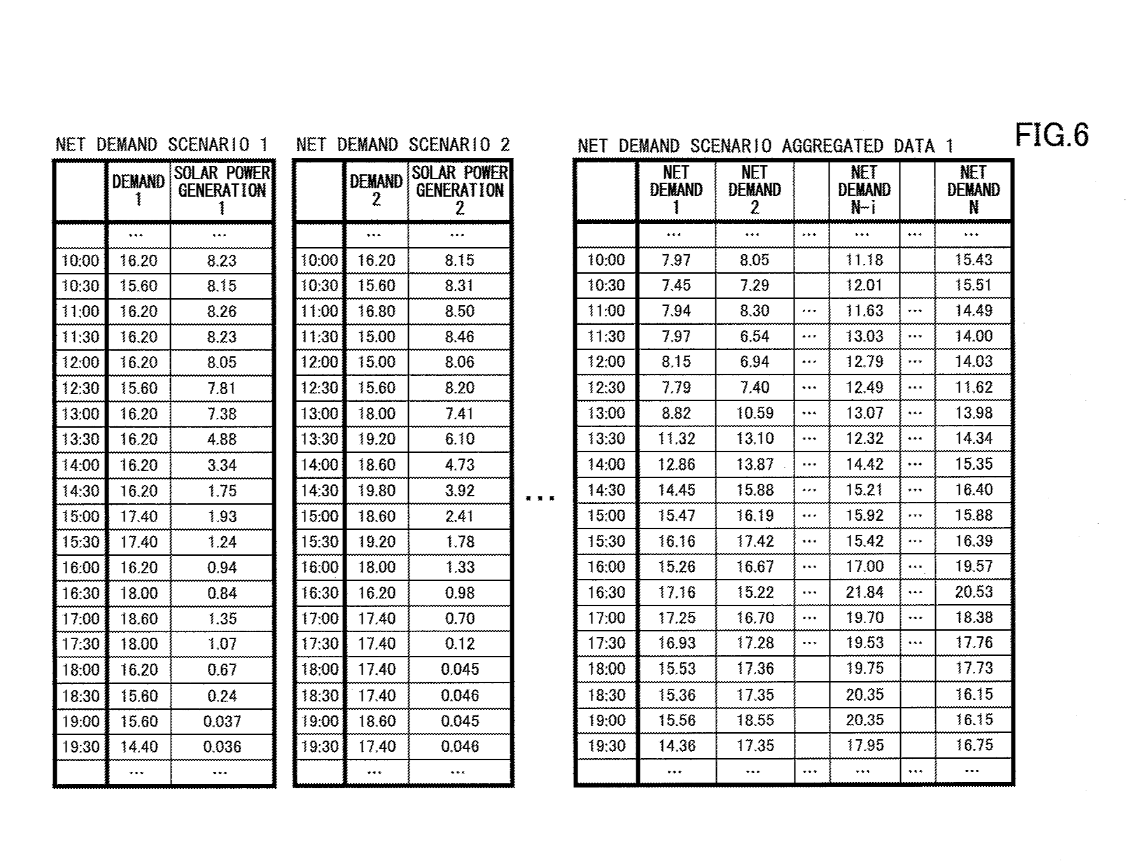

Next, referring back to FIG. 4, the reference procurement plan creating unit 11 generates a net demand scenario, by subtracting the values of the solar power generation observation scenario from the values of the respective unit times of the demand observation scenario (step S12). FIG. 6 is a diagram illustrating an example of the calculation of the net demand. Based on the extracted demand observation data and the solar power generation observation data, the solar power generation with respect to the demand per unit time is applied as the power to be supplied. That is, the difference between the demand and the solar power generation is calculated, and the result is generated as a net demand scenario (the power amount that needs to be supplied from the supply sources other than solar power generation, after supplying the solar power generation). It is assumed that there will be a plurality of extracted correspondence relationships between the demand and solar power generation in consideration of the impact of forecast errors. The left side of FIG. 6 indicates the correspondence relationships between the demand and the solar power generation of two scenarios, i.e., a net demand scenario 1 and a net demand scenario 2. The right side of FIG. 6 indicates an N number of net demand scenarios in a table, as net demand scenario aggregated data 1. The difference between the demand and the solar power generation of each time period in the net demand scenario 1 is stored in the field of the net demand 1. Similar calculation results of the net demand scenario 2 are stored in the field of the net demand 2.

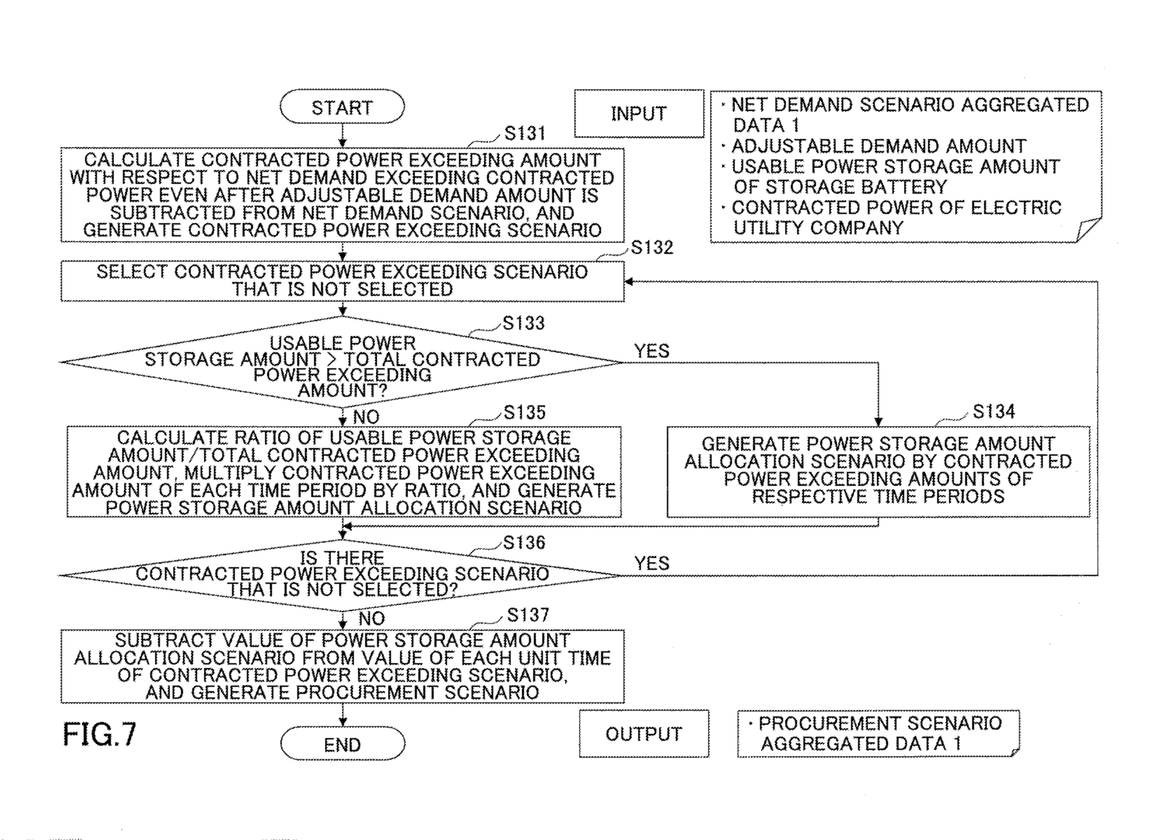

Next, referring back to FIG. 4, the reference procurement plan creating unit 11 generates a procurement scenario (step S13). FIG. 7 is a flowchart illustrating an example of a process of generating a procurement scenario (step S13 of FIG. 4). The procurement scenario generation process includes receiving input of the net demand scenario aggregated data, the adjustable demand amount and the usable power storage amount of the storage battery that are the equipment restrictions, and the contracted power of an electric utility company that is the upper limit in the purchase amount from the electric utility company. Furthermore, the procurement scenario generation process includes generating procurement scenario aggregated data with respect to each net demand scenario of the net demand scenario aggregated data.

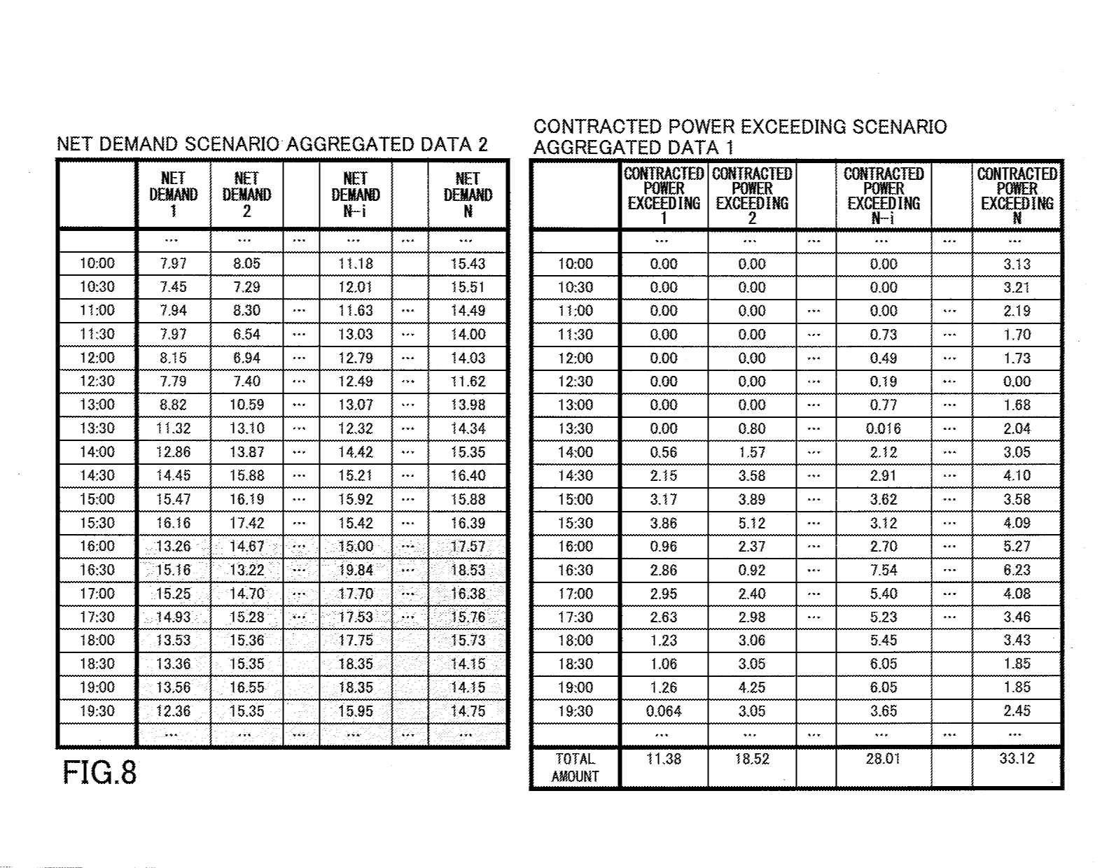

In FIG. 7, first, the reference procurement plan creating unit 11 calculates the contracted power exceeding amount with respect to the net demand exceeding the contracted power even after the adjustable demand amount is subtracted from the net demand scenario, and generates a contracted power exceeding scenario (step S131). FIG. 8 is a diagram illustrating an example of the calculation of a contracted power exceeding scenario. The left side of FIG. 8 indicates net demand scenario aggregated data 2. Specifically, when the adjustable demand amount is 2 kW from 16:00, the adjustable demand amount is subtracted from the net demand scenario aggregated data 1 (FIG. 6) to update the net demand scenario and obtain the net demand scenario aggregated data 2. Furthermore, the right side of FIG. 8 indicates contracted power exceeding scenarios (contracted power exceeding scenario aggregated data 1). Specifically, when the contracted power is 12.3 kW, the difference between the net demand and the contracted power is obtained with respect to the net demand exceeding 12.3 kW, and this difference is set as the contracted power exceeding amount. When the contracted power does not exceed 12.3 kW, zero is stored. These values are output as the contracted power exceeding scenarios (contracted power exceeding scenario aggregated data 1).

To supply the contracted power exceeding amount from the electric utility company, entails bearing a high cost to supply the power. Therefore, the purpose of the above process is to clarify the time periods in which the contracted power is exceeded and the exceeding amount of power, to create a plan for supplying power from sources other than the electric utility company and solar power generation in order to reduce cost. The total contracted power exceeding amount is calculated with respect to each contracted power exceeding scenario in the contracted power exceeding scenario aggregated data.

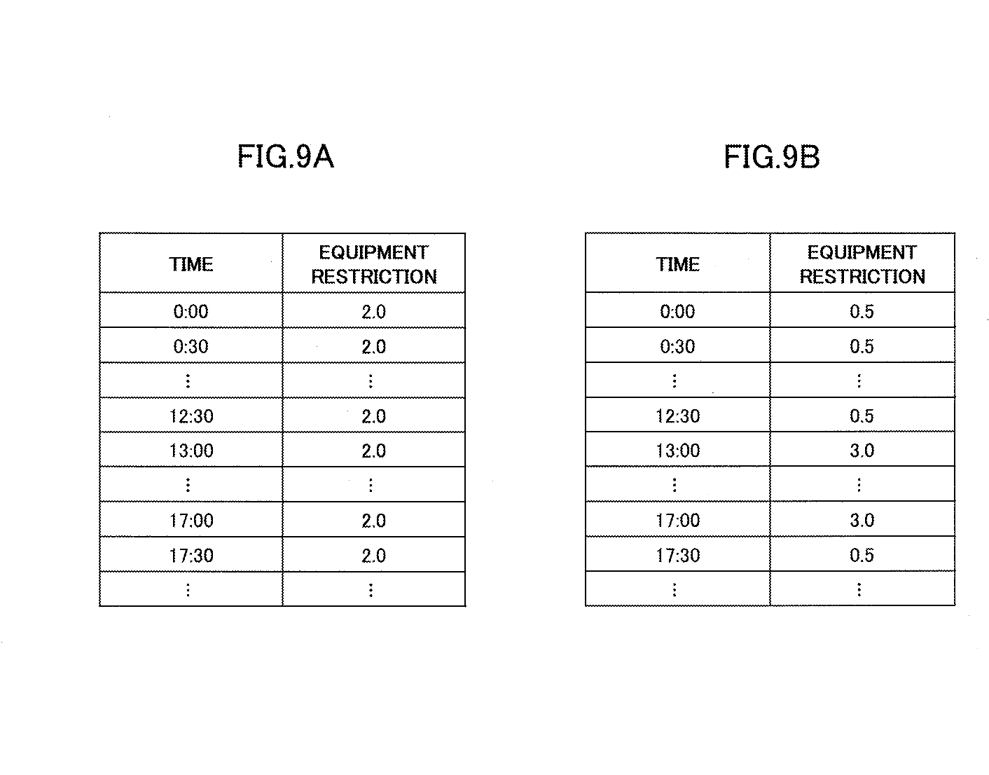

FIGS. 9A and 9B are diagrams illustrating examples of the equipment restriction data used in demand adjustment. This data indicates the upper limit in the adjustable demand amount dependent on the equipment. The table in FIG. 9A indicates an example in which the upper limit in the adjustment amount is fixed without depending on the time. The table in FIG. 9B indicates an example in which the upper limit in the adjustment amount is dependent on the time. The upper limit in the adjustment amount as indicated in these examples may be used, or the reduction amount may be determined by the ratio with respect to the demand.

Referring back to FIG. 7, the reference procurement plan creating unit 11 selects a contracted power exceeding scenario that is not selected (step S132), and performs the following process until there are no more contracted power exceeding scenarios that are not selected (NO in step S136).

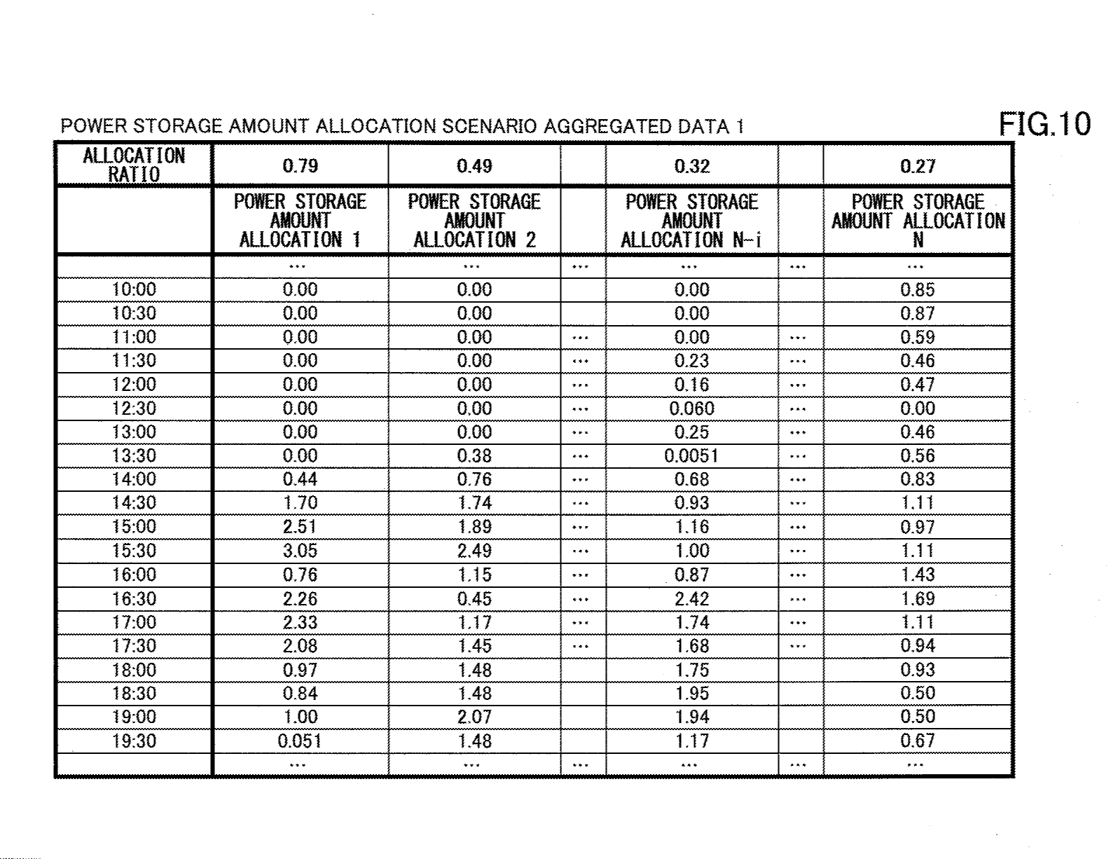

First, the reference procurement plan creating unit 11 compares the usable power storage amount and the total contracted power exceeding amount, with respect to the selected contracted power exceeding scenario (step S133). If the usable power storage amount is higher (YES in step S133), the reference procurement plan creating unit 11 generates a power storage amount allocation scenario by the contracted power exceeding amounts of the respective time periods (step S134). If the total contracted power exceeding amount is higher (NO in step S133), the reference procurement plan creating unit 11 calculates the ratio between the usable power storage amount and the total contracted power exceeding amount, multiples the contracted power exceeding amount of each time period by the ratio, and generates the power storage amount allocation scenario (step S135). FIG. 10 is a diagram illustrating an example of the calculation of the power storage amount allocation scenario. In FIG. 10, the total contracted power exceeding amount is higher than the usable power storage amount in all of the contracted power exceeding scenarios, and the ratio between the usable power storage amount and the total contracted power exceeding amount is obtained for the each of the contracted power exceeding scenarios, and the contracted power exceeding scenario is multiplied by the ratio, to output the power storage amount allocation scenarios (power storage amount allocation scenario aggregated data 1).

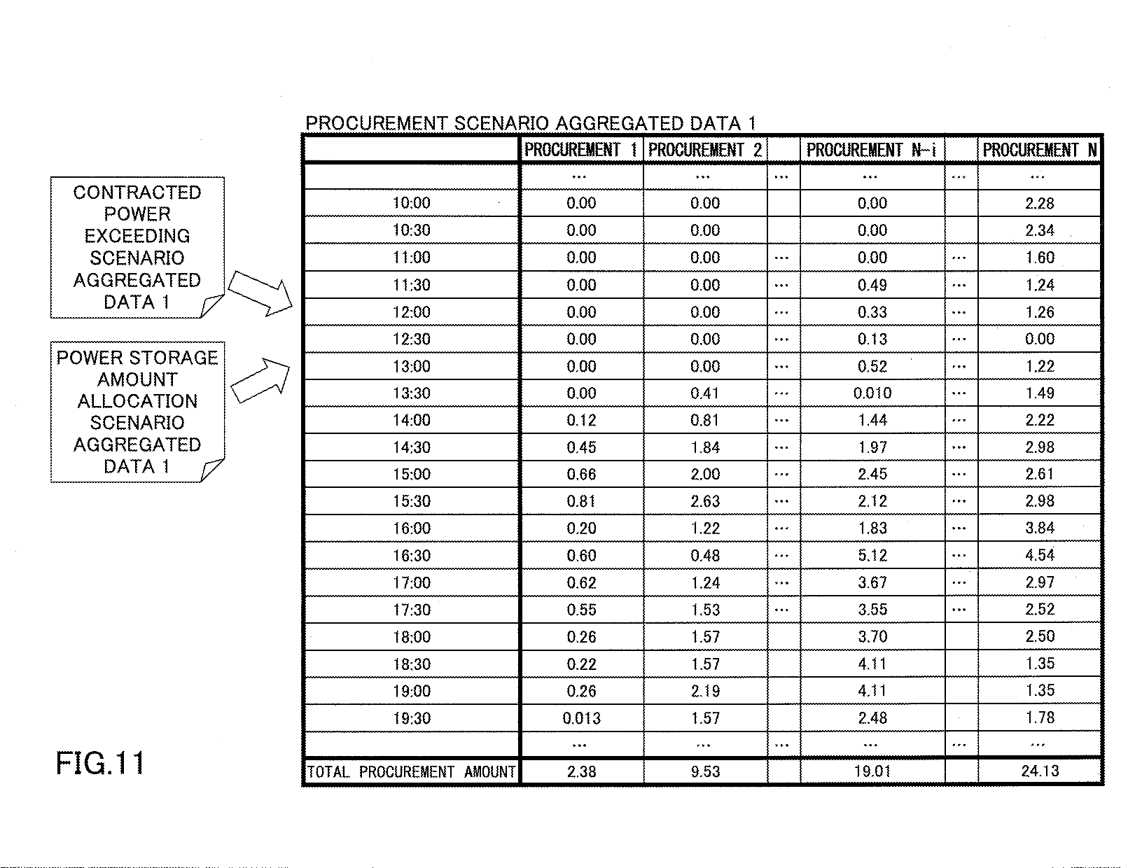

Referring back to FIG. 7, the reference procurement plan creating unit 11 subtracts the value of the power storage amount allocation scenario from the value of each unit time of the contracted power exceeding scenario, and generates a procurement scenario (step S137). FIG. 11 is a diagram illustrating an example of the calculation of a procurement scenario. In FIG. 11, with respect to a corresponding scenario of the contracted power exceeding scenario aggregated data and the power storage amount allocation scenario aggregated data, the allocated power storage amount is subtracted from the contracted power exceeding amount, and procurement scenarios (procurement scenario aggregated data 1) are output. With respect to each of the procurement scenarios, the total procurement amount is also calculated. This procurement scenario corresponds to the contracted power exceeding amount that cannot be compensated for by demand adjustment or by a storage battery, and therefore this procurement scenario corresponds to the power amount to be procured from the market.

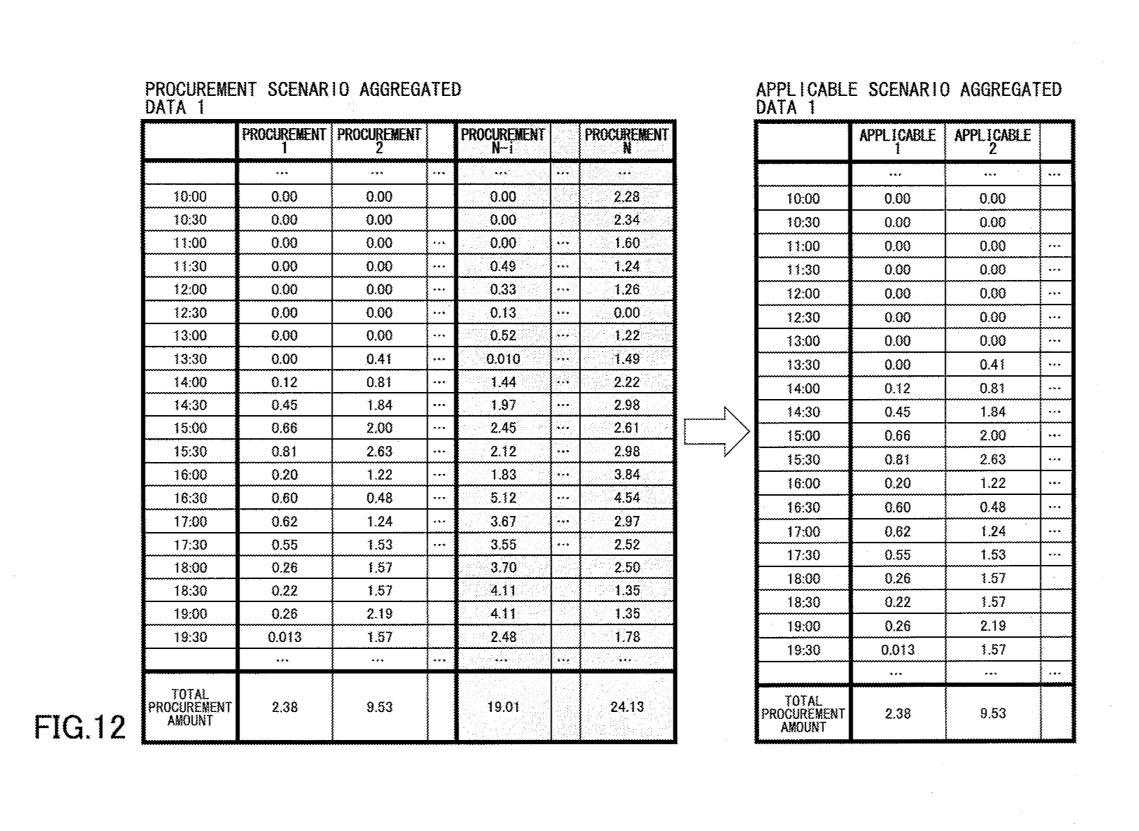

Next, referring back to FIG. 4, the reference procurement plan creating unit 11 extracts applicable scenarios. Specifically, the reference procurement plan creating unit 11 excludes, as inapplicable scenarios, the top-ranking X % of procurement scenarios that have a large total procurement amount (inapplicable scenario ratio) among the generated procurement scenarios, to extract the applicable scenarios (step S14). FIG. 12 is a diagram illustrating an example of extraction of applicable scenarios. FIG. 12 illustrates that applicable scenarios (applicable scenario aggregated data 1) are extracted. The applicable scenarios (applicable scenario aggregated data 1) are extracted by excluding, as inapplicable scenarios, the top-ranking X % of procurement scenarios that have a large procurement amount among the procurement scenarios included in the procurement scenario aggregated data. The purpose of this process is as follows. Specifically, it is rare that the forecast substantially deviates from the actual amount. Therefore, if the procurement amount is determined based on the assumption that the forecast will substantially deviate from the actual amount, the procurement amount will be highly excessive in many scenarios. In order to avoid such a situation, the above process is performed.

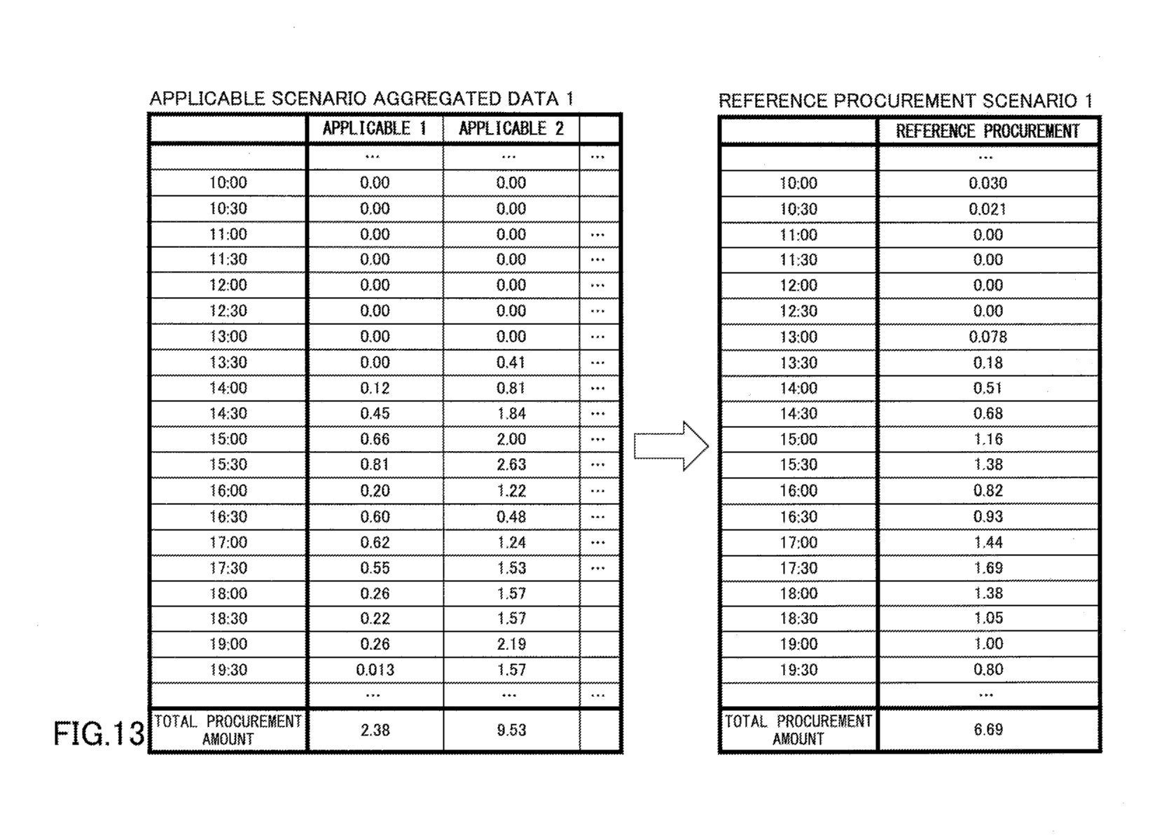

Next, referring back to FIG. 4, the reference procurement plan creating unit 11 calculates the expectation values of the procurement amount per unit time in the applicable scenario aggregated data, and generates a reference procurement scenario (step S15). FIG. 13 is a diagram illustrating an example of the calculation of a reference procurement scenario. In FIG. 13, in the applicable scenario aggregated data, the unit times are sequentially selected. The expectation values of procurement amounts in the unit times of the respective applicable scenarios are calculated. Based on the expectation values, a reference procurement scenario (reference procurement scenario 1) is output. The expectation value is obtained by the average value of the procurement amounts of the respective applicable scenarios in each of the time periods. For example, in the case of 15:00, the procurement amount of the applicable scenario 1 is 0.66 kW, the procurement amount of the applicable scenario 2 is 2.00 kW, and also in consideration of the procurement amounts of the other applicable scenarios, the expectation value is calculated to be 1.16 kW, which is stored as the value of 15:00 of the reference procurement scenario. When the plan is created at the time point of the preceding day, under the circumstances that it is unknown as to which net demand scenario will actually occur, there is a need to avoid a situation where the market procurement amount is too small and therefore a contracted power exceeding amount arises. Also, there is a need to avoid a situation where a large amount of power is procured from the market for the purpose of preventing the contracted power from being exceeded and consequently the power supply from an inexpensive electric utility company cannot be used. The purpose of the above process is to create a procurement plan by which the market procurement amount is an appropriate amount in many contracted power exceeding scenarios, when the storage battery is used and the demand is adjusted. The expectation values of the respective time periods in the individual minimum procurement scenarios are used to create a reference procurement scenario.

Next, referring back to FIG. 4, as the final process, the reference procurement plan creating unit 11 compares the total procurement amounts of the respective applicable scenarios in the applicable scenario aggregated data with the total procurement amount of the reference procurement scenario, and extracts the applicable scenarios having a higher total procurement amount than that of the reference procurement scenario, as the procurement adjustment scenario (step S16). The purpose of this process is to extract the scenarios for which the procurement amount is to be adjusted. Specifically, the total procurement amount of a procurement scenario, which is used to calculate the reference procurement scenario, may exceed the total procurement amount of the reference procurement scenario. In this case, the necessary procurement amount is not satisfied by the reference procurement scenario, and therefore the restriction condition is violated. Such a scenario, which violates the restriction condition, is extracted as the procurement adjustment scenario for which the procurement amount is to be adjusted.

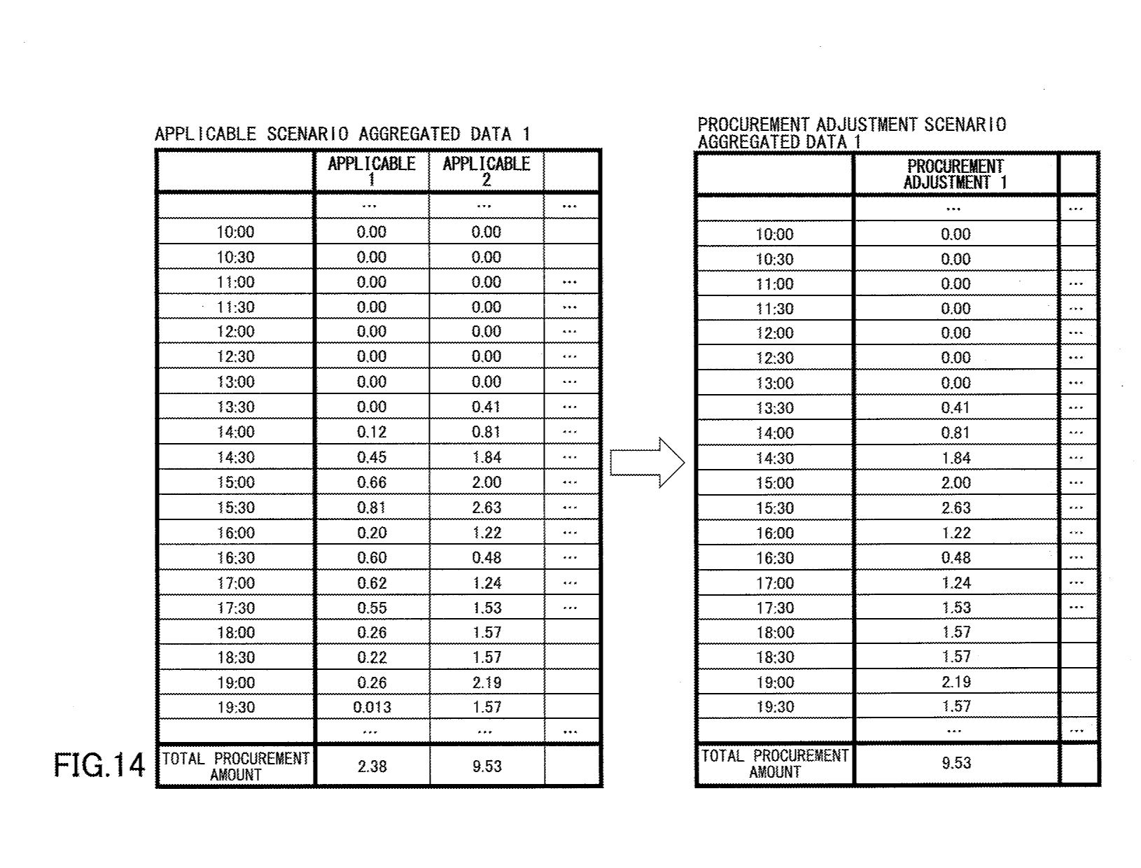

FIG. 14 is a diagram illustrating the extraction of a procurement adjustment scenario. In FIG. 14, the total procurement amount of each applicable scenario and the total procurement amount of the reference procurement scenario are compared, with respect to the applicable scenario aggregated data. The total procurement amount of the applicable scenario 1 is 2.38 kWh, which is less than the total procurement amount of the reference procurement scenario 6.69 kWh, and therefore the procurement amount is sufficient by the reference procurement scenario. Next, the total procurement amount of the applicable scenario 2 is 9.53 kWh, which exceeds the total procurement amount of the reference procurement scenario 6.69 kWh, and therefore the procurement amount is insufficient by the reference procurement scenario. Therefore, the applicable scenario 2 is extracted as a procurement adjustment scenario. The same process is repeated for other applicable scenarios, and the procurement adjustment scenarios (procurement adjustment scenario aggregated data 1) are extracted.

### [Reference Procurement Plan Adjusting Unit 12]

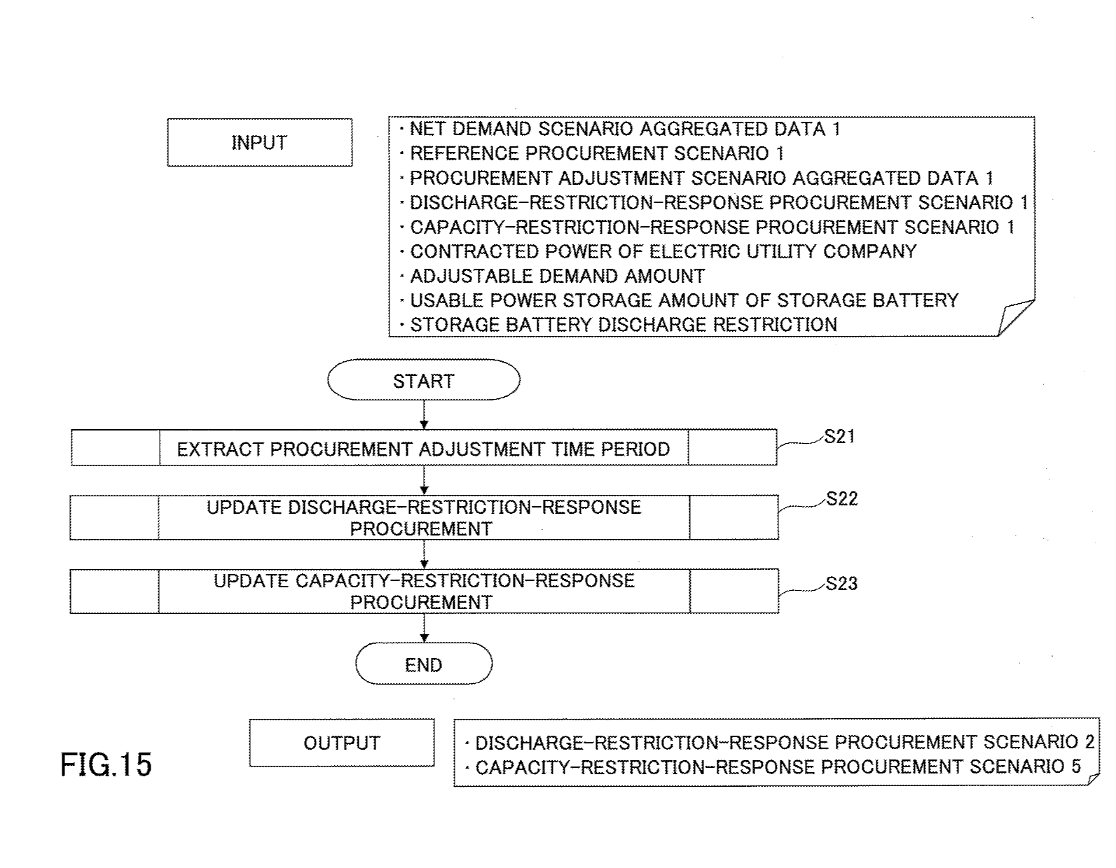

FIG. 15 is a flowchart illustrating an example of a process by the reference procurement plan adjusting unit 12. The feature of the reference procurement plan adjusting unit 12 is as follows. Specifically, with respect to the procurement adjustment scenario aggregated data extracted by the reference procurement plan creating unit 11, in order to resolve the restriction condition violation that occurs even by procuring power by the reference procurement scenario, the procurement amount for adjusting the reference procurement scenario is calculated, mainly for the time periods in which the contracted power exceeding amount is large. The reference procurement plan adjusting unit 12 receives input of net demand scenario aggregated data, a reference procurement scenario, procurement adjustment scenario aggregated data, a discharge-restriction-response procurement scenario, a capacity-restriction-response procurement scenario, the contracted power of an electric utility company, the adjustable demand amount, the usable power storage amount of the storage battery, and the storage battery discharge restriction. Furthermore, the reference procurement plan adjusting unit 12 outputs a discharge-restriction-response procurement scenario and a capacity-restriction-response procurement scenario. The processes include a procurement adjustment time period extracting process for extracting the time periods that need adjustment, in which restriction condition violation of the reference procurement scenario may occur (step S21), a discharge-restriction-response procurement updating process for calculating the procurement amount to respond to the procurement amount exceeding the discharge restriction (step S22), and a capacity-restriction-response procurement updating process for calculating the procurement amount to respond to the procurement amount exceeding the capacity restriction (step S23).

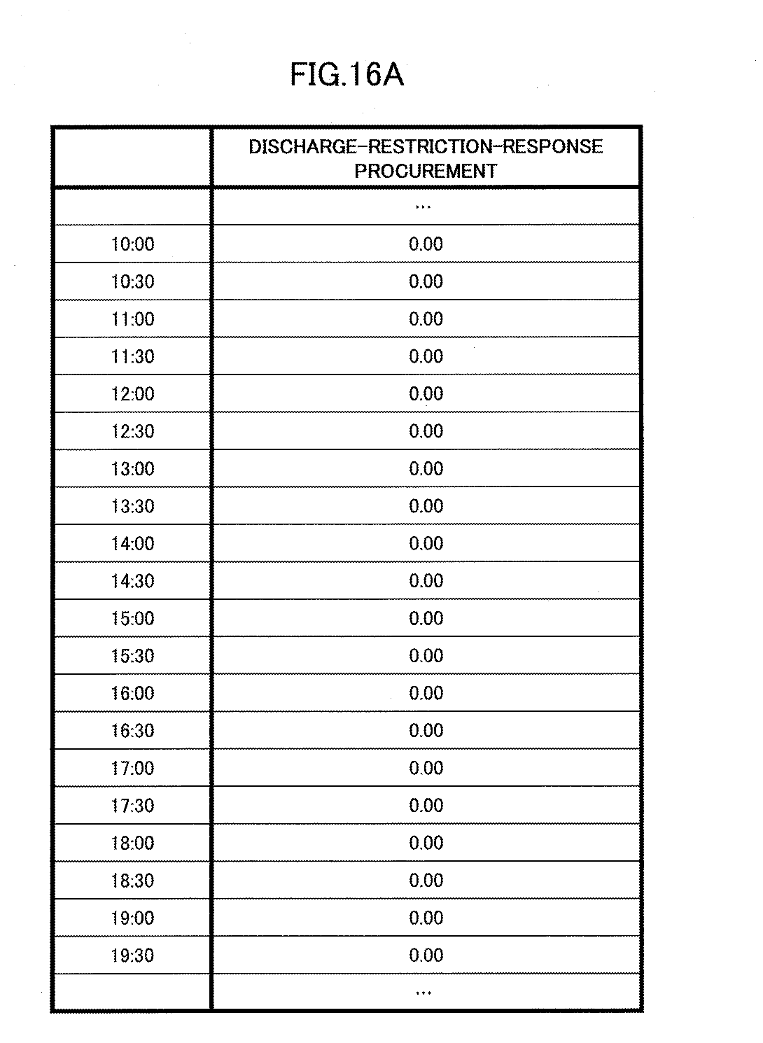

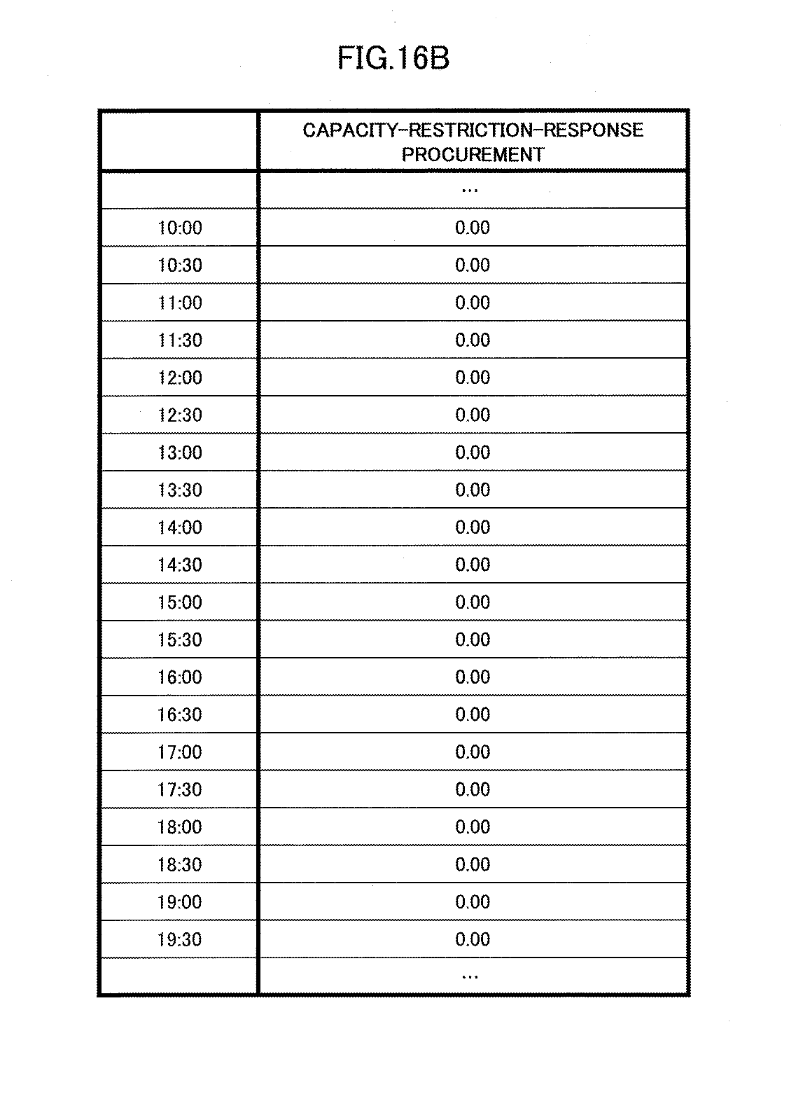

FIGS. 16A and 16B are diagrams illustrating examples of data formats of a discharge-restriction-response procurement scenario and a capacity-restriction-response procurement scenario. FIG. 16A illustrates a discharge-restriction-response procurement scenario 1 and FIG. 16B illustrates a capacity-restriction-response procurement scenario 1. In a subsequent process, this data is updated. Before the process starts, the values of the respective time periods are initialized by zero.

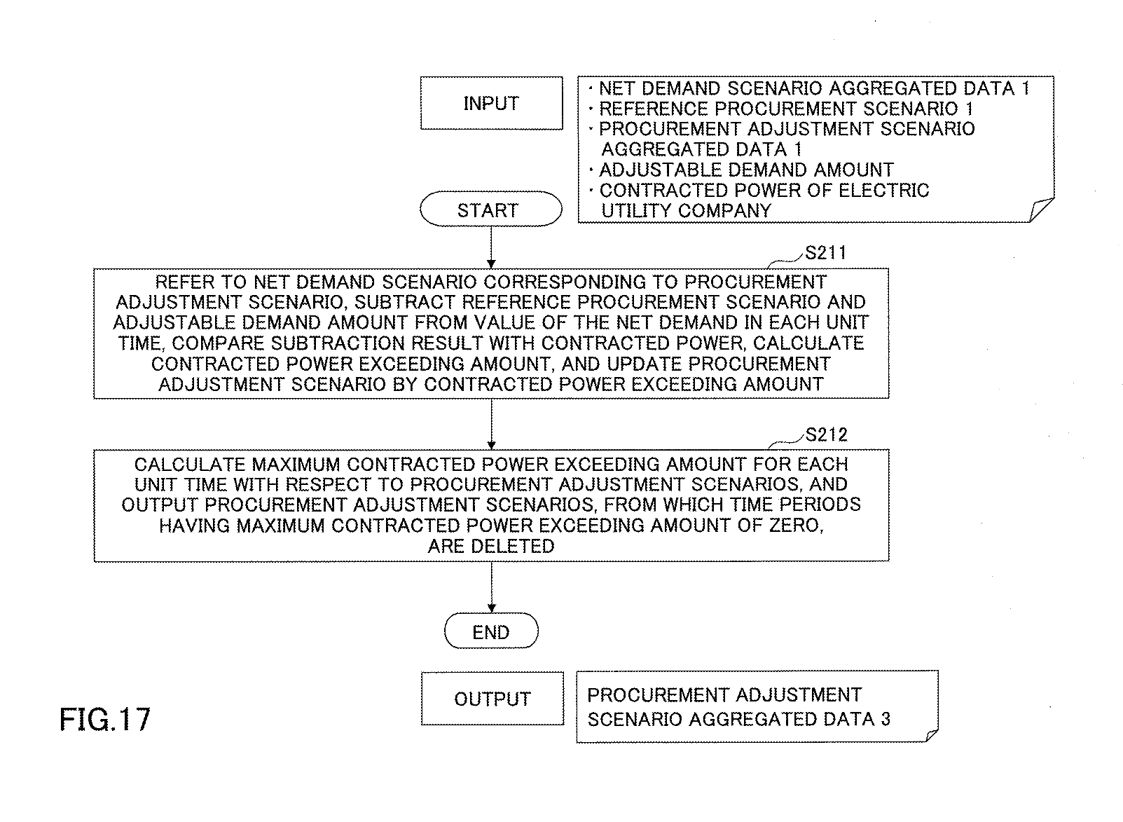

FIG. 17 is a flowchart illustrating an example of the procurement adjustment time period extracting process (step S21 of FIG. 15). In the procurement adjustment time period extracting process, the input information is the net demand scenario aggregated data, a reference procurement scenario, procurement adjustment scenario aggregated data, the adjustable demand amount, and the contracted power of an electric utility company. The output information is the procurement adjustment scenario aggregated data obtained by extracting the procurement adjustment time periods.

In FIG. 17, first, the reference procurement plan adjusting unit 12 refers to the net demand scenario corresponding to the procurement adjustment scenario, subtracts the reference procurement scenario and the adjustable demand amount from the value of the net demand in each unit time, compares the subtraction result with the contracted power, calculates the contracted power exceeding amount, and updates the procurement adjustment scenario by the contracted power exceeding amount (step S211). In this process, in order to clarify the procurement range, which corresponds to a deficiency in the procurement amount that arises by the reference procurement scenario but cannot be compensated for by the storage battery, the following is performed. Specifically, the contracted power exceeding amount is recalculated upon subtracting the reference procurement scenario and the adjustable demand amount from the net demand scenario (net demand scenario aggregated data 1) corresponding to each of the procurement adjustment scenarios, instead of from the procurement amount (procurement adjustment scenario aggregated data 1) in which the power storage amount is allocated depending on each of the procurement adjustment scenarios.

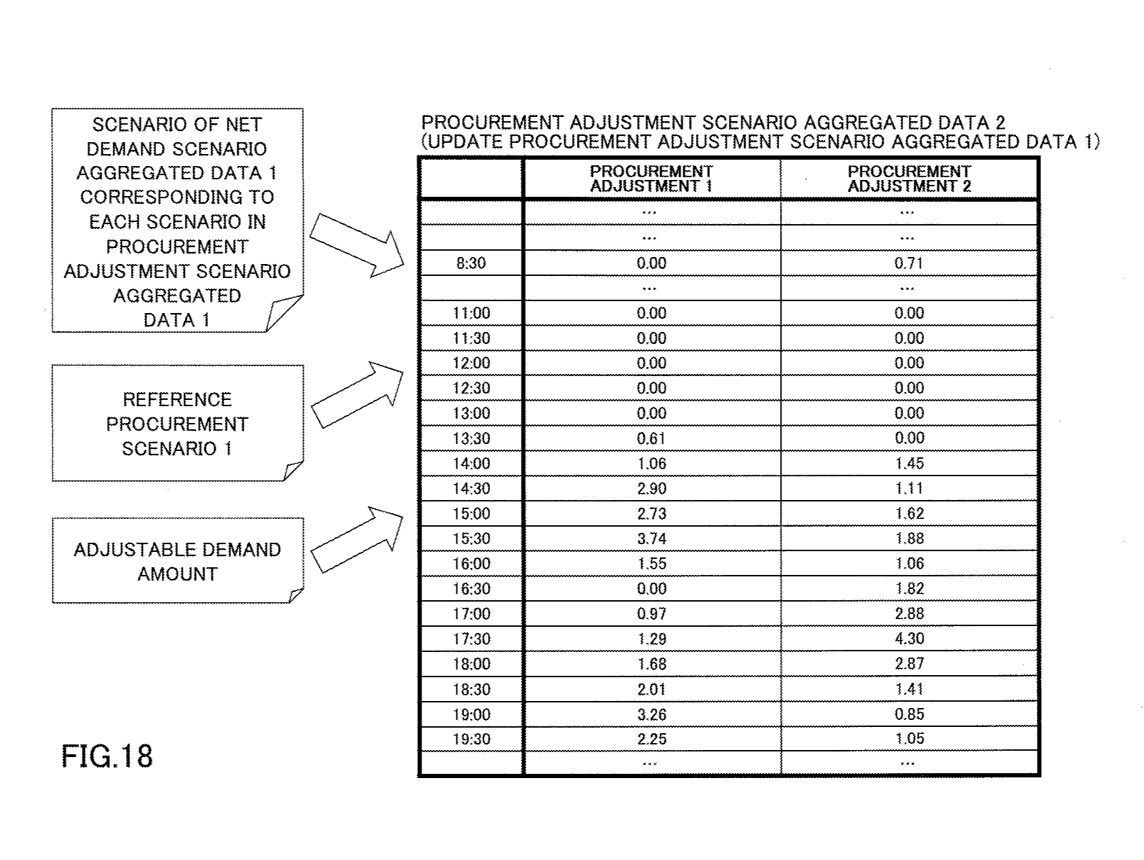

FIG. 18 is a diagram illustrating an example of updating the procurement adjustment scenario. In FIG. 18, the reference procurement plan adjusting unit 12 refers to the net demand scenario corresponding to the procurement adjustment scenario. The reference procurement plan adjusting unit 12 subtracts the value of the reference procurement scenario from the value of each unit time in the net demand scenario. The reference procurement plan adjusting unit 12 subtracts 2 kW, which is the adjustable demand amount, from the value of each unit time in the net demand scenario from and beyond 16:00. If the value, which is obtained after performing the above subtractions, exceeds 12.3 kW that is the contracted power, the amount that exceeds 12.3 kW is calculated, and the calculated amount is used to update the procurement adjustment scenario (procurement adjustment scenario aggregated data 2). When the net demand does not exceed the contracted power, zero is stored.

Next, referring back to FIG. 17, the reference procurement plan adjusting unit 12 calculates the maximum contracted power exceeding amount for each unit time with respect to the procurement adjustment scenarios, and outputs the procurement adjustment scenarios, from which the time periods having a maximum contracted power exceeding amount of zero, are deleted (step S212). In the present embodiment, the time periods are narrowed down to the time periods, which require additional procurement for responding to the restriction condition violation with respect to the procurement adjustment scenario, and the violations are resolved for the corresponding time periods, to alleviate the load of the process. That is, the time periods in which a restriction condition violation is unlikely to occur due to the impact of the forecast error and the relationship between the net demand and the contracted power, are excluded from the targets of the process of resolving the restriction condition violation. Particularly, the significant impact of the solar power generation forecast error is likely to occur only in the limited time periods during which power is being generated.

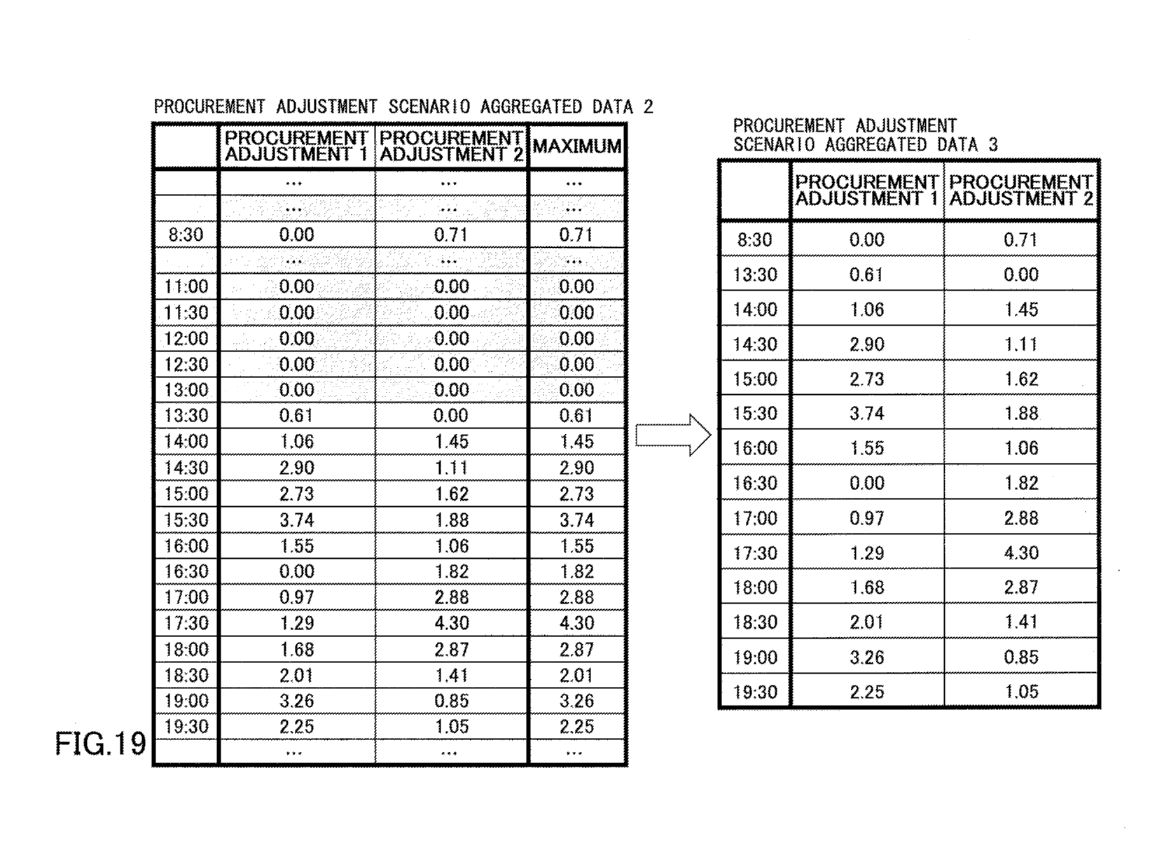

FIG. 19 is a diagram illustrating the extraction of the procurement adjustment time periods. In the left side of FIG. 19 (procurement adjustment scenario aggregated data 2), the maximum contracted power exceeding amount of each unit time in the updated procurement adjustment scenario aggregated data, is calculated. As a result of this process, when the contracted power is not exceeded in any of the procurement adjustment scenarios, the maximum value is zero, and the time periods having a maximum value of zero are deleted from the table. In FIG. 19, the contracted power is mainly exceeded in the afternoon. Thus, in the procurement adjustment scenario 2, in the time periods before noon, the maximum contracted power exceeding amount is zero (the contracted power is not exceeded) in all of the time periods except for the time period of 8:30, and the time periods indicating zero are deleted. The remaining time periods are output as the procurement adjustment scenario aggregated data (procurement adjustment scenario aggregated data 3) in which the procurement adjustment time periods are extracted. In this example, as a matter of simplification, only two procurement adjustment scenarios are indicated; however, this process is usually performed with respect to two or more procurement adjustment scenarios. Also in the following examples, for the same reason, only two procurement adjustment scenarios are processed.

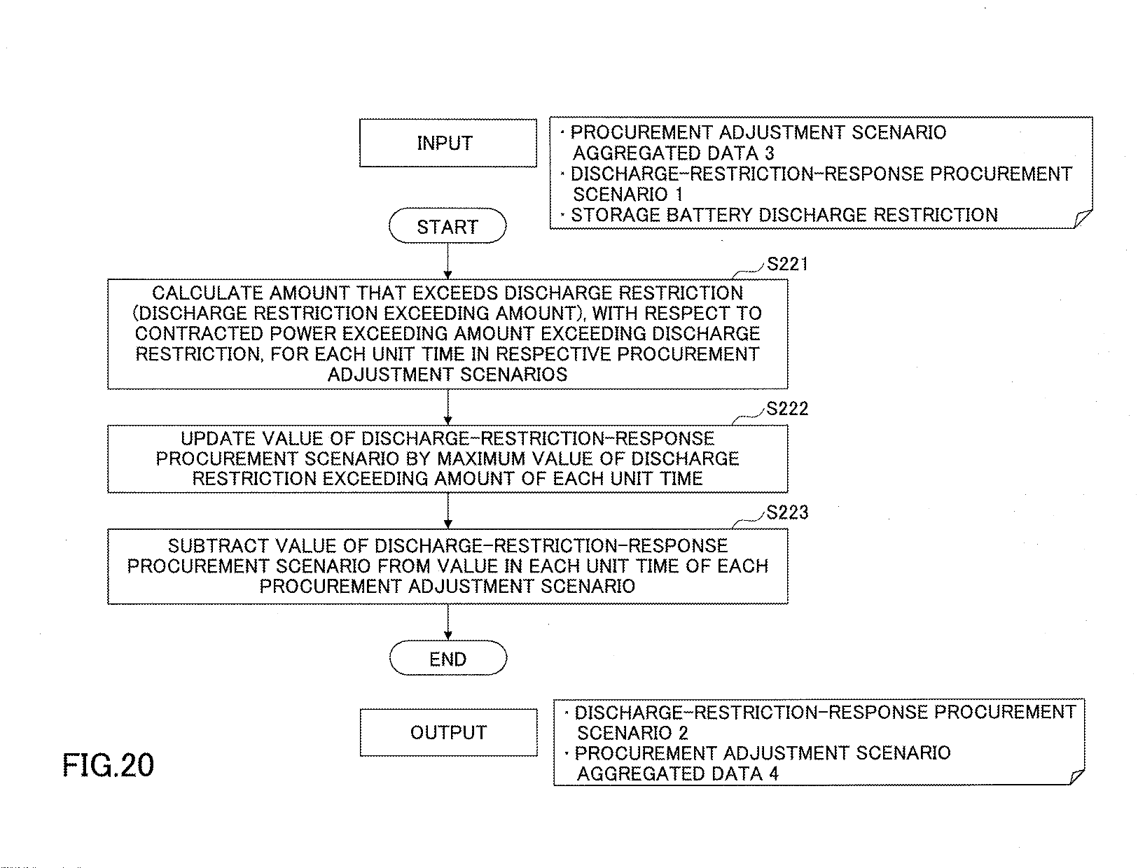

FIG. 20 is a flowchart illustrating an example of the discharge-restriction-response procurement updating process (step S22 of FIG. 15). In the discharge-restriction-response procurement updating process, the input information is the procurement adjustment scenario aggregated data, the discharge-restriction-response procurement scenario, and the storage battery discharge restriction. Furthermore, the output information is the updated discharge-restriction-response procurement scenario and the procurement adjustment scenario aggregated data to which the discharge-restriction-response procurement scenario is applied. In the present embodiment, the procurement amount of the preceding day is determined with respect to a plurality of scenarios in consideration of the forecast error. With respect to the discharge restriction, for example, when there is even one scenario in a certain unit time that violates the discharge restriction, procurement is needed for resolving this violation. The purpose of this process is to calculate the minimum additional procurement amount for resolving the discharge restriction violation of the storage battery with respect to the contracted power exceeding amount.

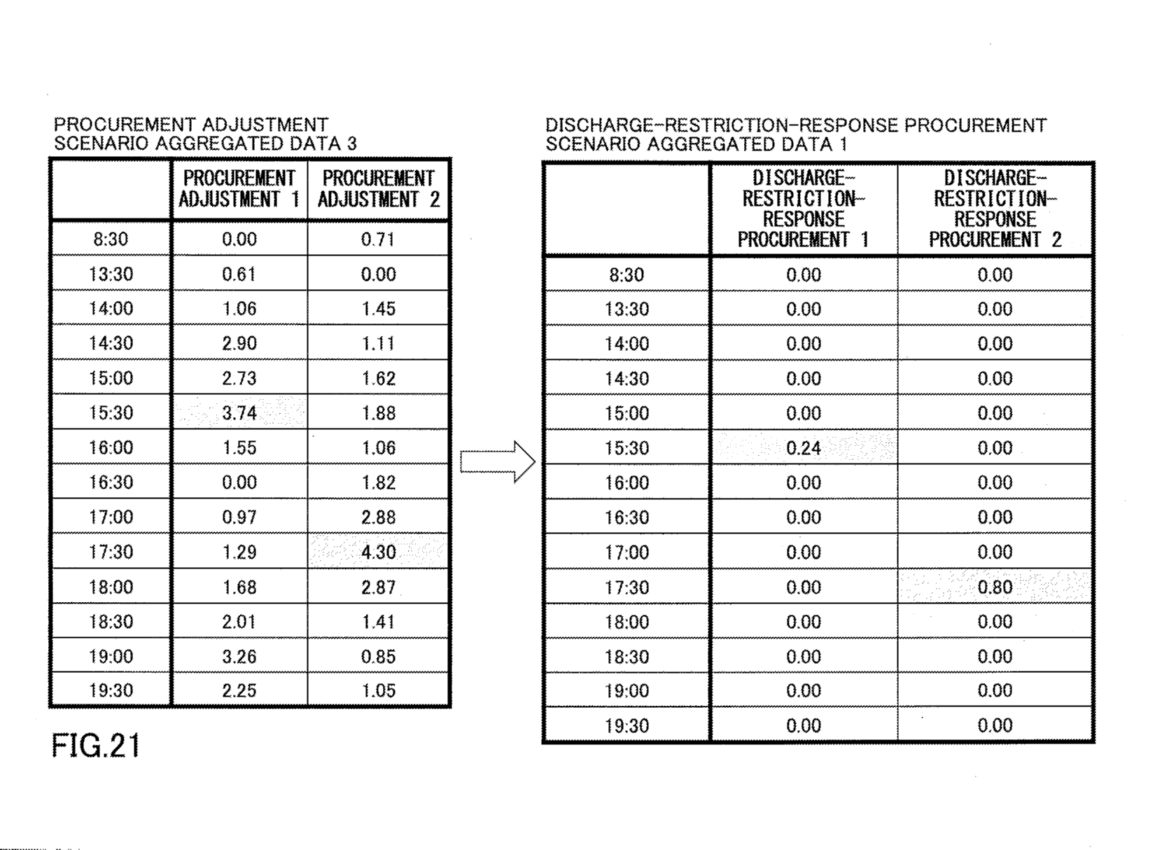

In FIG. 20, first, the reference procurement plan adjusting unit 12 calculates the amount that exceeds the discharge restriction (discharge restriction exceeding amount), with respect to the contracted power exceeding amount exceeding the discharge restriction, for each unit time in the respective procurement adjustment scenarios (step S221). FIG. 21 is a diagram illustrating an example of the calculation of the discharge-restriction-response procurement. In FIG. 21, in the procurement adjustment scenario aggregated data 3, at 15:30 of the procurement adjustment scenario 1 and at 17:30 of the procurement adjustment scenario 2, the discharge restriction is exceeded. Therefore, the respective differences are calculated (scenario 1: 3.74-3.50, scenario 2: 4.30-3.50). The calculation results are expressed in the right table (discharge-restriction-response procurement scenario aggregated data 1), and the power is procured such that the contracted power exceeding amount exceeding the discharge restriction in an individual scenario is limited within the discharge restriction range.

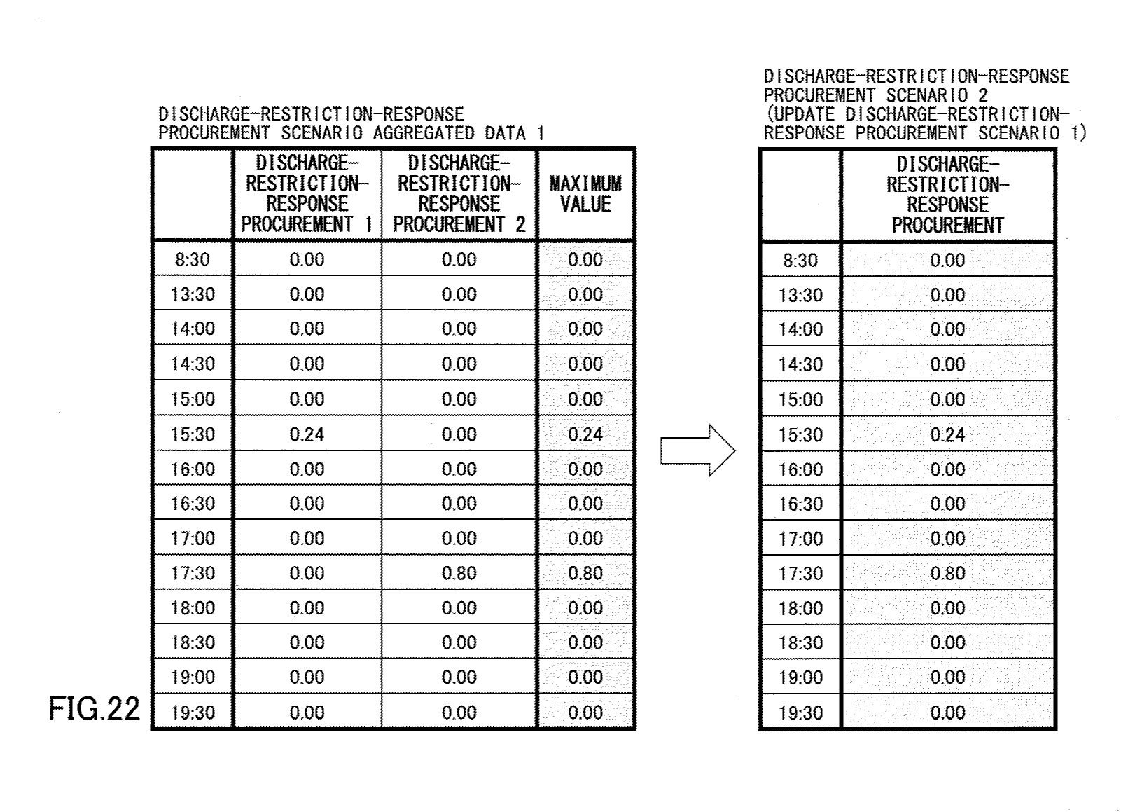

Next, referring back to FIG. 20, the reference procurement plan adjusting unit 12 updates the value of the discharge-restriction-response procurement scenario by the maximum value of the discharge restriction exceeding amount of each unit time (step S222). In order to respond to, not only the discharge restriction exceeding amount of an individual procurement adjustment scenario, but to also respond to the discharge restriction exceeding amounts of a plurality of procurement adjustment scenarios, there is a need to respond to all of the discharge restriction exceeding amounts that may occur in the respective time periods. Therefore, the maximum discharge restriction exceeding amount is calculated for each time period, and this maximum value is the procurement amount for responding to the discharge restriction exceeding amount of a plurality of procurement adjustment scenarios. FIG. 22 is a diagram illustrating an example of the updating of the discharge-restriction-response procurement. In FIG. 22, after obtaining the maximum value of discharge-restriction-response procurement of each time period of the individual scenarios in the discharge-restriction-response procurement aggregated data, the value of each unit time in the discharge-restriction-response procurement is updated by the obtained maximum value (discharge-restriction-response procurement scenario 2)

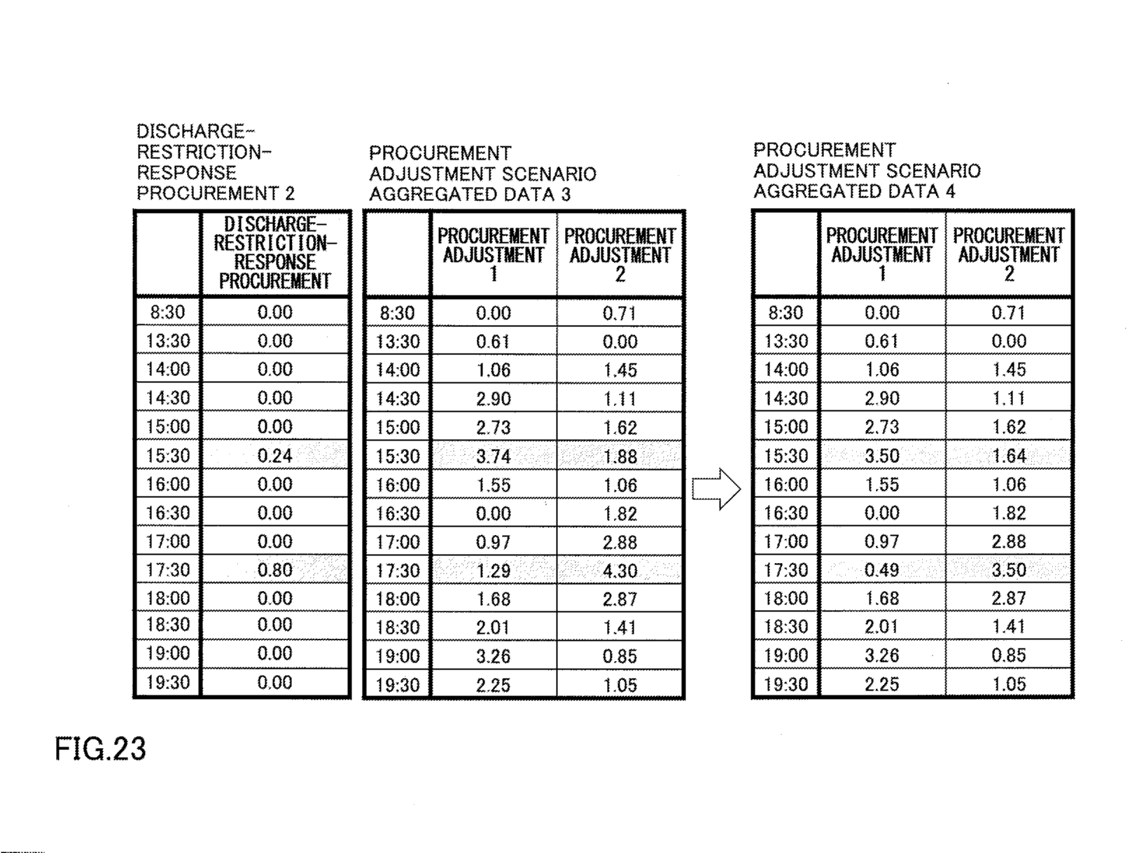

Then, referring back to FIG. 20, the reference procurement plan adjusting unit 12 subtracts the value of the discharge-restriction-response procurement scenario from the value in each unit time of each procurement adjustment scenario (step S223). The purpose of this process is as follows. Specifically, the procurement, which is for responding to the discharge restriction in a certain unit time of a certain procurement adjustment scenario, is a procurement that is needed in consideration of the impact of a forecast error. Therefore, the impact is factored into all of the procurement adjustment scenarios with priority. FIG. 23 is a diagram illustrating an example of the calculation of the procurement after responding to the discharge restriction. In FIG. 23, the procurement for responding to the discharge restriction is applied to the procurement adjustment scenario. The procurement at 15:30 in the procurement adjustment scenario 1 for resolving the discharge restriction violation, is applied to the procurement adjustment scenario 2 (0.24 kW is subtracted from the procurement amount at 15:30 of the procurement adjustment scenario 1 and the procurement adjustment scenario 2). Furthermore, the procurement at 17:30 in the procurement adjustment scenario 2 for resolving the discharge restriction violation, is applied to the procurement adjustment scenario 1 (0.8 kW is subtracted from the procurement amount at 17:30 of the procurement adjustment scenario 1 and the procurement adjustment scenario 2). Then, the updated procurement adjustment scenarios are output (procurement adjustment scenario aggregated data 4).

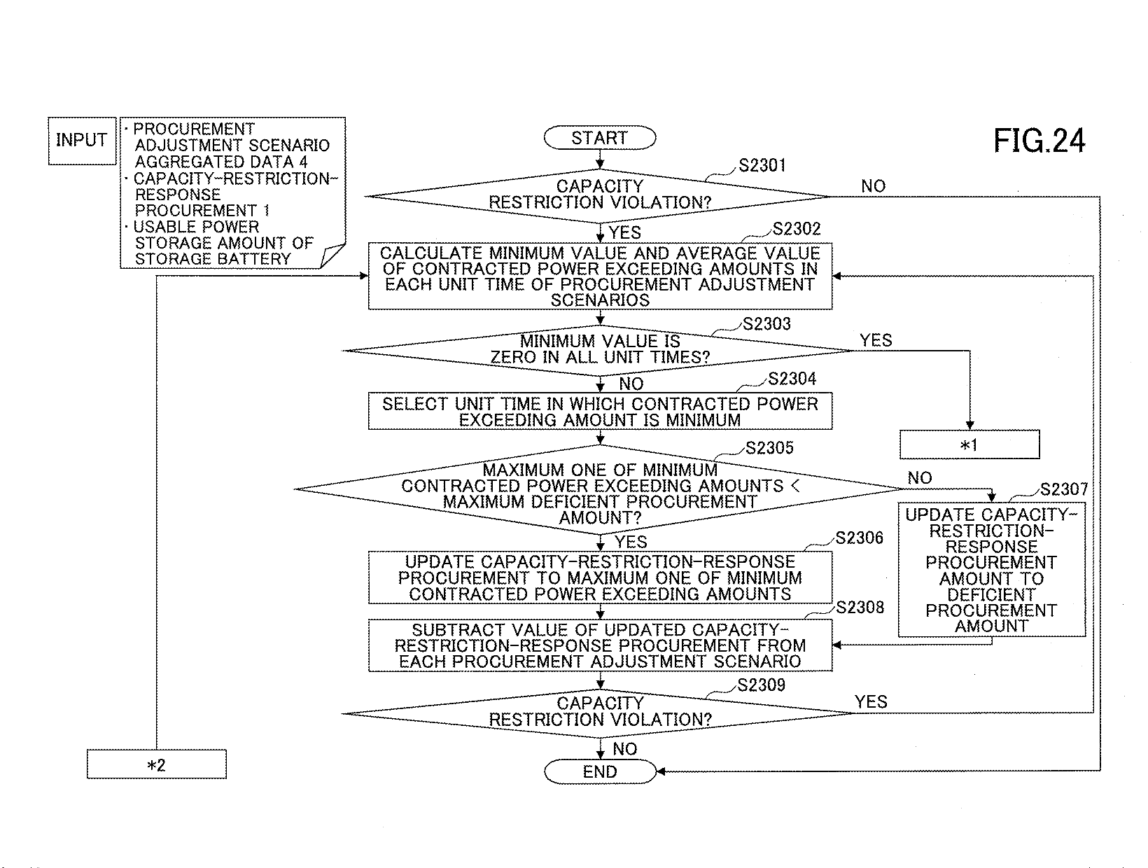

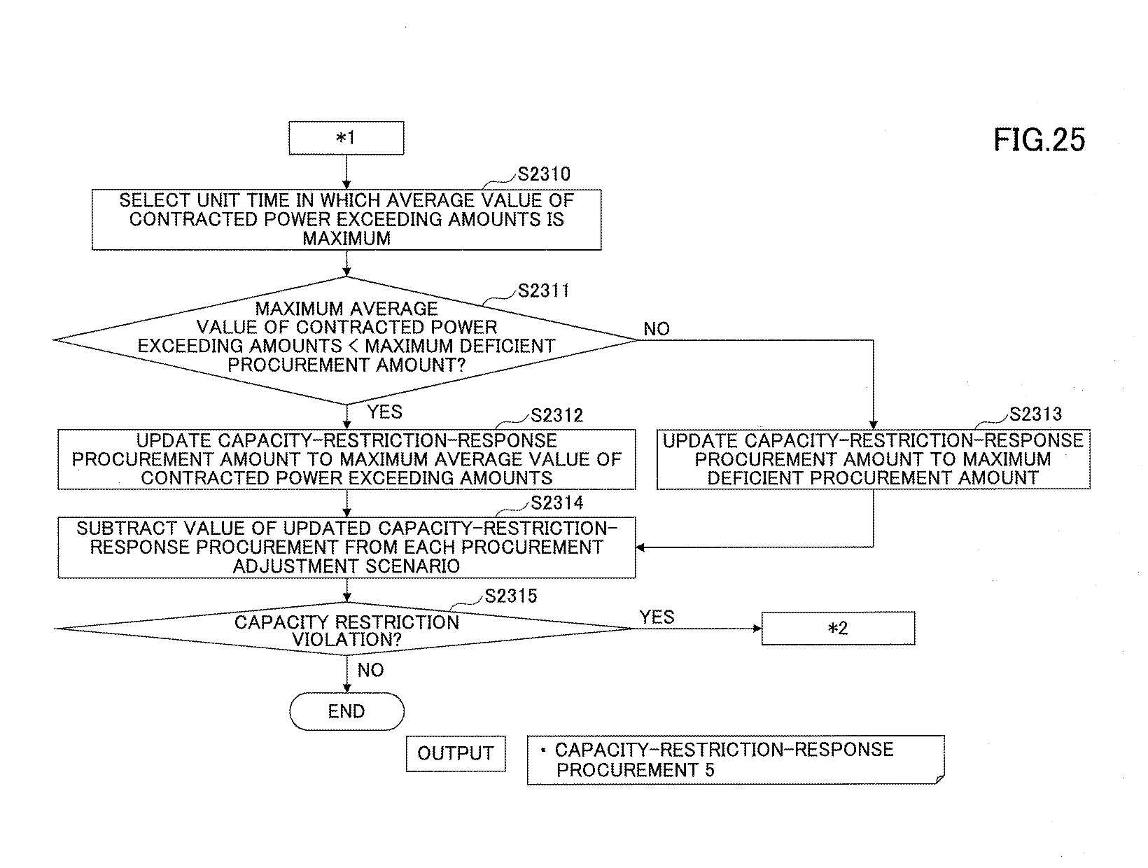

FIGS. 24 and 25 are flowcharts illustrating an example of the capacity-restriction-response procurement updating process (step S23 of FIG. 15). The discharge restriction violation depending on an individual procurement adjustment scenario needs to be resolved without depending on other procurement adjustment scenarios. Therefore, after resolving the violation by the above process, the procurement is increased such that the total procurement amount does not exceed the capacity restriction, in consideration of how much the contracted power is exceeded in each unit time in a plurality of procurement adjustment scenarios. According to how much the contracted power is exceeded in a unit time in procurement adjustment scenarios for which procurement is to be performed, it is determined whether the procurement will contribute to the resolution of the capacity restriction violation. That is, if power is procured for a unit time in which the contracted power is frequently exceeded, the power storage amount does not have to be used for this procured amount. On the other hand, in a unit time in which the contracted power is rarely exceeded, it is preferable to use the storage battery with priority when the contracted power is exceeded, because the total procurement amount will be decreased in consideration of a plurality of procurement adjustment scenarios.

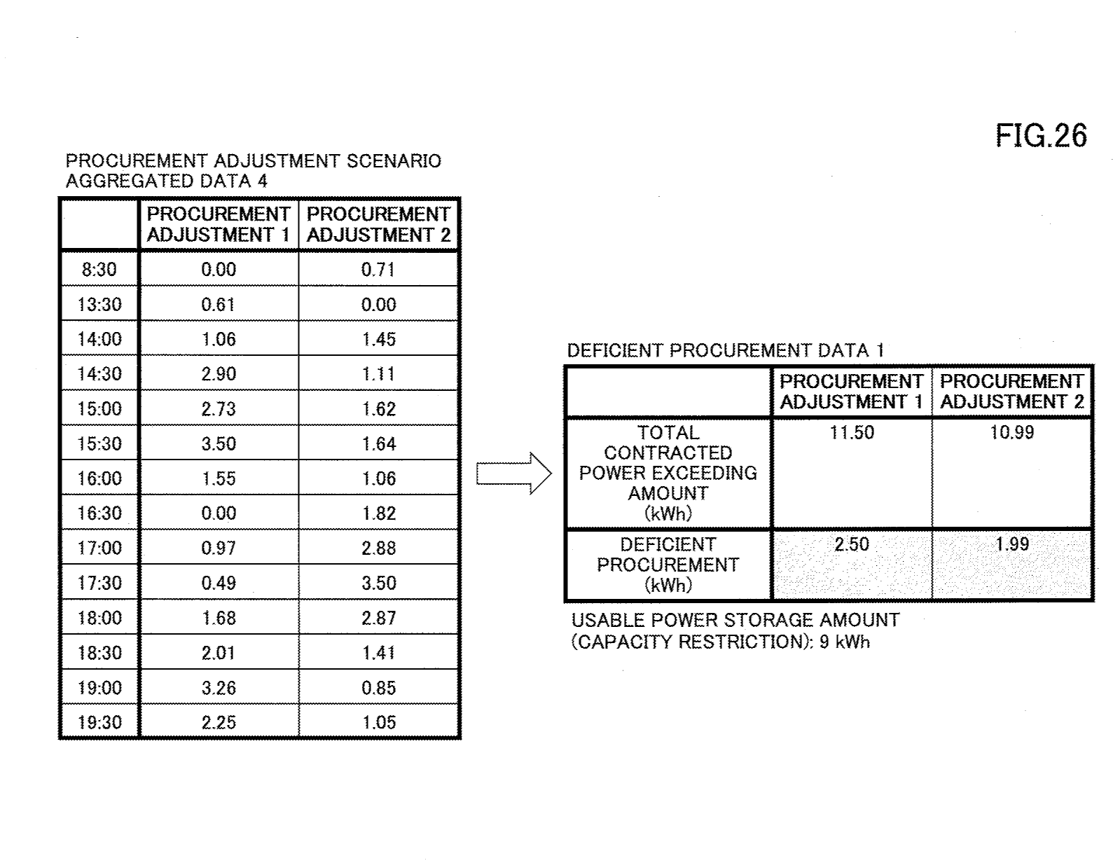

In FIG. 24, the reference procurement plan adjusting unit 12 first evaluates the capacity restriction violation (step S2301). In this evaluation, the reference procurement plan adjusting unit 12 calculates the total contracted power exceeding amount of each of the procurement adjustment scenarios, and obtains the difference between the calculated total contracted power exceeding amount and the usable power storage amount. When the difference is less than zero, the evaluation is zero (no deficiency). If any one of the scenarios is evaluated to have a deficiency in the procurement, an evaluation is made that the capacity restriction is violated. FIG. 26 is a diagram illustrating an example of the evaluation of the capacity restriction violation. In FIG. 26, the usable power storage amount is 9 kWh, and the total contracted power exceeding amount exceeds the usable power storage amount in both the procurement adjustment scenario 1 and the procurement adjustment scenario 2, and therefore an evaluation is made that the capacity restriction is violated. Note that for the purpose of comparison with the power storage amount, the total contracted power exceeding amount is converted into power amounts in units of 30 minutes, and then the sum of these power amounts is used for calculation.

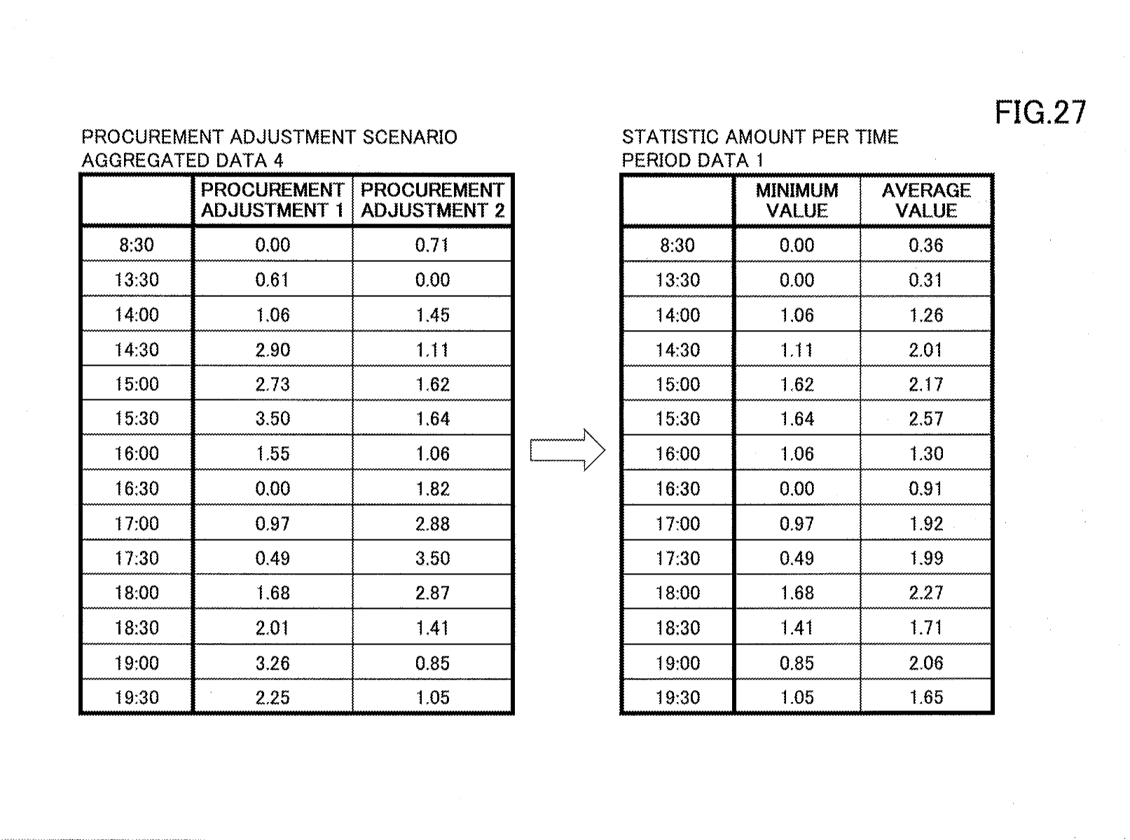

Next, referring back to FIG. 24, if the capacity restriction is still violated even after resolving the discharge restriction violation is resolved by procurement (YES in step S2301), the reference procurement plan adjusting unit 12 calculates the minimum value and the average value (expectation value) of the contracted power exceeding amounts in each unit time of the procurement adjustment scenarios (step S2302). As described above, it is preferable to procure power for a time period in which the contracted power is frequently exceeded, in order to resolve the capacity restriction violation. Furthermore, if there is a unit time in which the contracted power exceeding amounts are overlapping in all scenarios, it would be ideal to procure only the amount that is overlapping. For this reason, the minimum value of the contracted power exceeding amounts in each unit time is calculated. However, even when the contracted power is exceeded in many procurement adjustment scenarios, if there is even one procurement adjustment scenario in which the contracted power is not exceeded, the minimum value will be zero. Therefore, in order to be prepared for a status where the minimum value of the contracted power exceeding amounts becomes zero in all of the unit times, the average value is also calculated. FIG. 27 is a diagram illustrating an example of the calculation of the minimum value and the average value of contracted power exceeding amounts in each unit time. In FIG. 27, the minimum value and the average value in each unit time of the procurement adjustment scenarios are calculated.

Next, referring back to FIG. 24, when the minimum value of the contracted power exceeding amounts is not zero in any of the unit times (NO in step S2303), the reference procurement plan adjusting unit 12 selects the unit time in which the contracted power exceeding is minimum (step S2304). Otherwise, the process is performed as described below with reference to FIG. 25.

The reference procurement plan adjusting unit 12 selects the unit time (step S2304), and subsequently, when the maximum one of the minimum values of contracted power exceeding amounts is less than or equal to the maximum deficient procurement amount (YES in step S2305), the reference procurement plan adjusting unit 12 updates the capacity-restriction-response procurement amount to the maximum one of the minimum values of contracted power exceeding amounts (step S2306). Furthermore, when the maximum deficient procurement amount is less than the maximum one of the minimum values of contracted power exceeding amounts (NO in step S2305), the reference procurement plan adjusting unit 12 updates the capacity-restriction-response procurement amount to the maximum deficient procurement amount (step S2307). The purpose of this process is as follows. Specifically, when the deficient procurement amount becomes small, the procurement is adjusted by an amount corresponding to the deficient procurement amount, such that the capacity-restriction-response procurement amount is not set to be greater than or equal to the deficient procurement amount.

Then, the reference procurement plan adjusting unit 12 subtracts the value of the updated capacity-restriction-response procurement from each of the procurement adjustment scenarios (step S2308), and makes an evaluation as to whether the procurement adjustment scenario violates the capacity restriction (step S2309). When the capacity restriction violation is resolved (NO in step S2309), the process is completed. When the capacity restriction is violated (YES in step S2309), the reference procurement plan adjusting unit 12 performs the capacity-restriction-response procurement updating process until the capacity restriction violation is resolved.

Here, when the process returns to the case where the minimum value of the contracted power exceeding amounts is zero in all of the unit times (YES in step S2303), this means that there are no time periods in which the contracted power exceeding amounts are overlapping for all of the procurement adjustment scenarios. Therefore, in the process of FIG. 25, the reference procurement plan adjusting unit 12 selects a unit time in which the average value of the contracted power exceeding amounts is maximum (step S2310). Then, when the maximum average value of the contracted power exceeding amounts is less than or equal to the maximum deficient procurement amount (YES in step S2311), the reference procurement plan adjusting unit 12 updates the capacity-restriction-response procurement amount to the maximum average value of the contracted power exceeding amounts (step S2312). Furthermore, when the maximum deficient procurement amount is less than the maximum average value of the contracted power exceeding amounts (NO in step S2311), the reference procurement plan adjusting unit 12 updates the capacity-restriction-response procurement amount to the maximum deficient procurement amount (step S2313).

Then, the reference procurement plan adjusting unit 12 subtracts the value of the updated capacity-restriction-response procurement from each of the procurement adjustment scenarios (step S2314), and makes an evaluation as to whether the procurement adjustment scenario violates the capacity restriction (step S2315). When the capacity restriction violation is resolved (NO in step S2315), the process is completed. When the capacity restriction is violated (YES in step S2315), the reference procurement plan adjusting unit 12 performs the capacity-restriction-response procurement updating process of FIG. 24 until the capacity restriction violation is resolved.

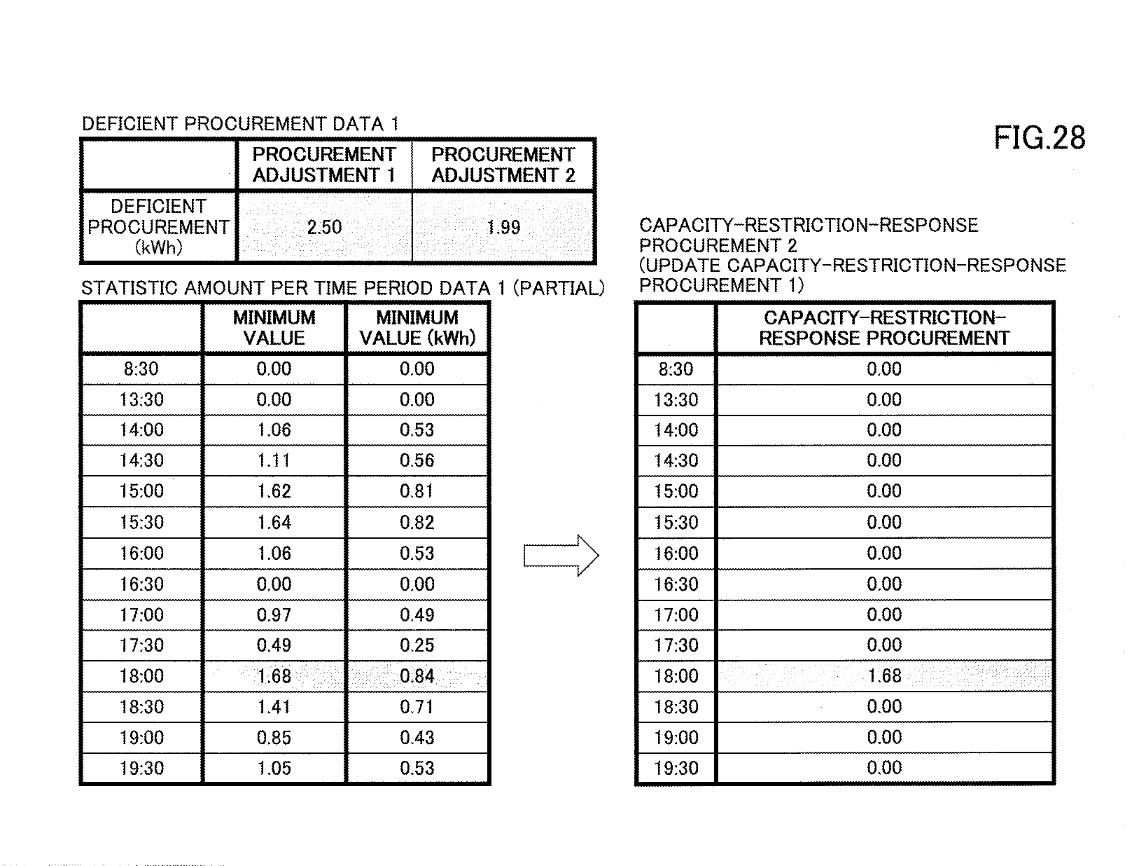

FIG. 28 is a diagram illustrating an example of the updating of the capacity-restriction-response procurement. In FIG. 28, the deficient procurement amount is not zero in the procurement adjustment scenario 1 or the procurement adjustment scenario 2, and therefore the capacity restriction is violated. Furthermore, all of the minimum values of the contracted power exceeding amounts are not zero, and therefore the time 18:00, which corresponds to the maximum one of the minimum values, is selected. The maximum one of the minimum contracted power exceeding amounts 0.84 kWh (the power amount value of 30 minutes of 1.68 kW) is less than the maximum deficient procurement amount 2.50 kWh, and therefore the value of the capacity-restriction-response procurement amount at 18:00 is updated to 1.68 kW that is the maximum one of the minimum contracted power exceeding amounts (capacity-restriction-response procurement 2).

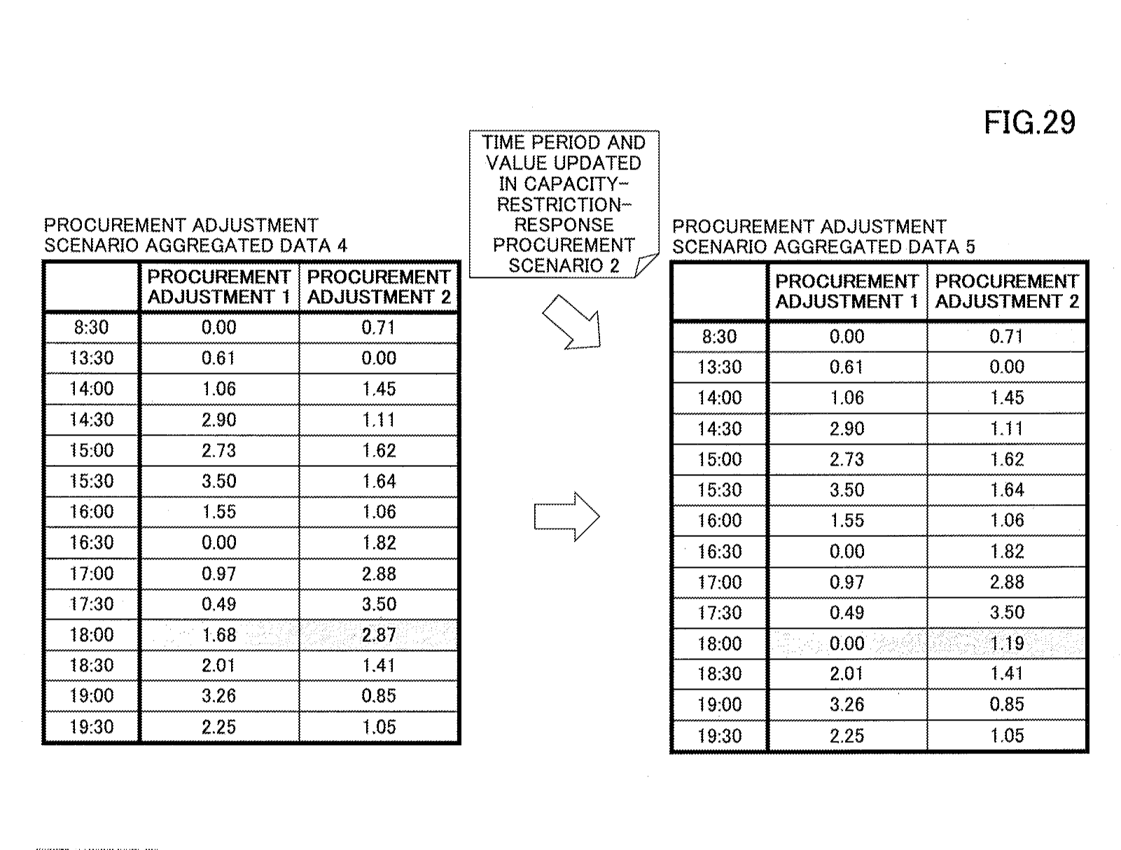

FIG. 29 is a diagram illustrating an example of the calculation of the procurement after responding to the capacity restriction. In FIG. 29, 1.68 kW, which is the value of 18:00 that has been updated the last time with respect to the procurement adjustment scenarios, is subtracted from both the procurement adjustment scenario 1 and the procurement adjustment scenario 2 (procurement adjustment scenario 1 at 18:00: 1.68-1.68=0.00, procurement adjustment scenario 2 at 18:00: 2.87-1.68=1.19). The result of the calculation is indicated in the table on the right (procurement adjustment scenario aggregated data 5).

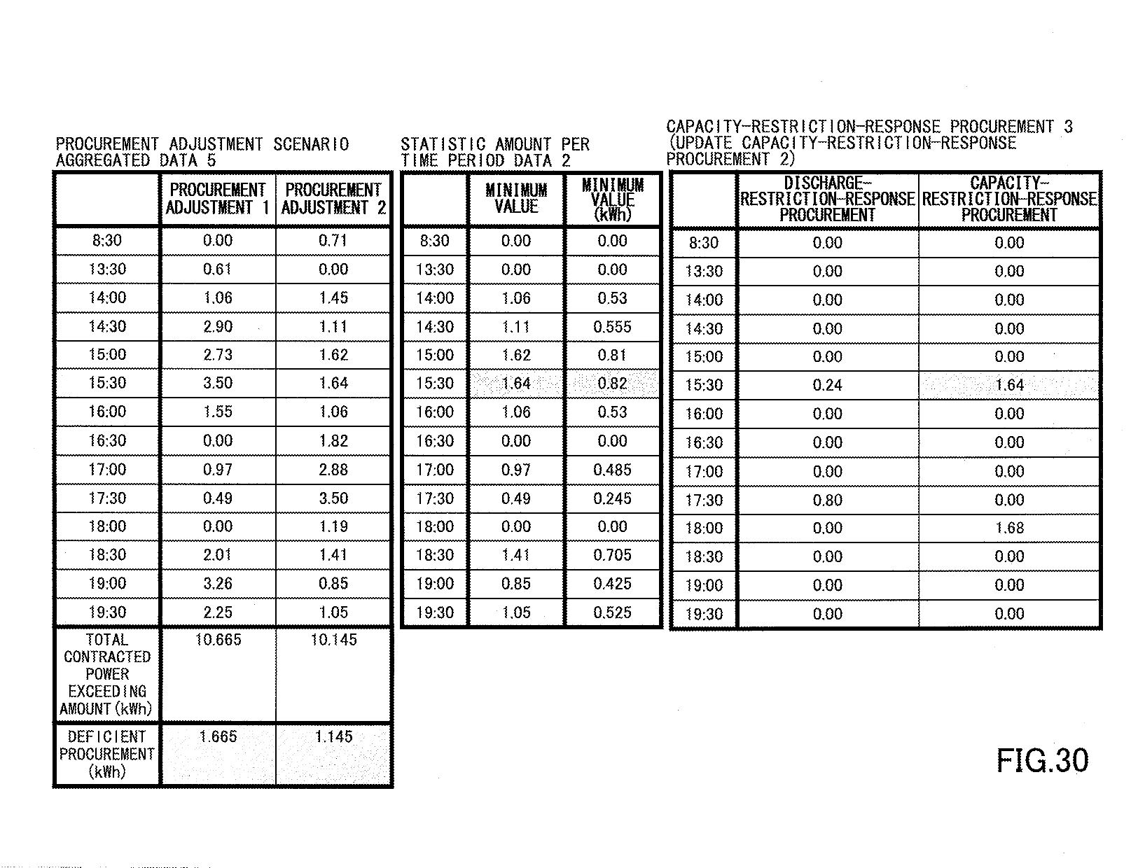

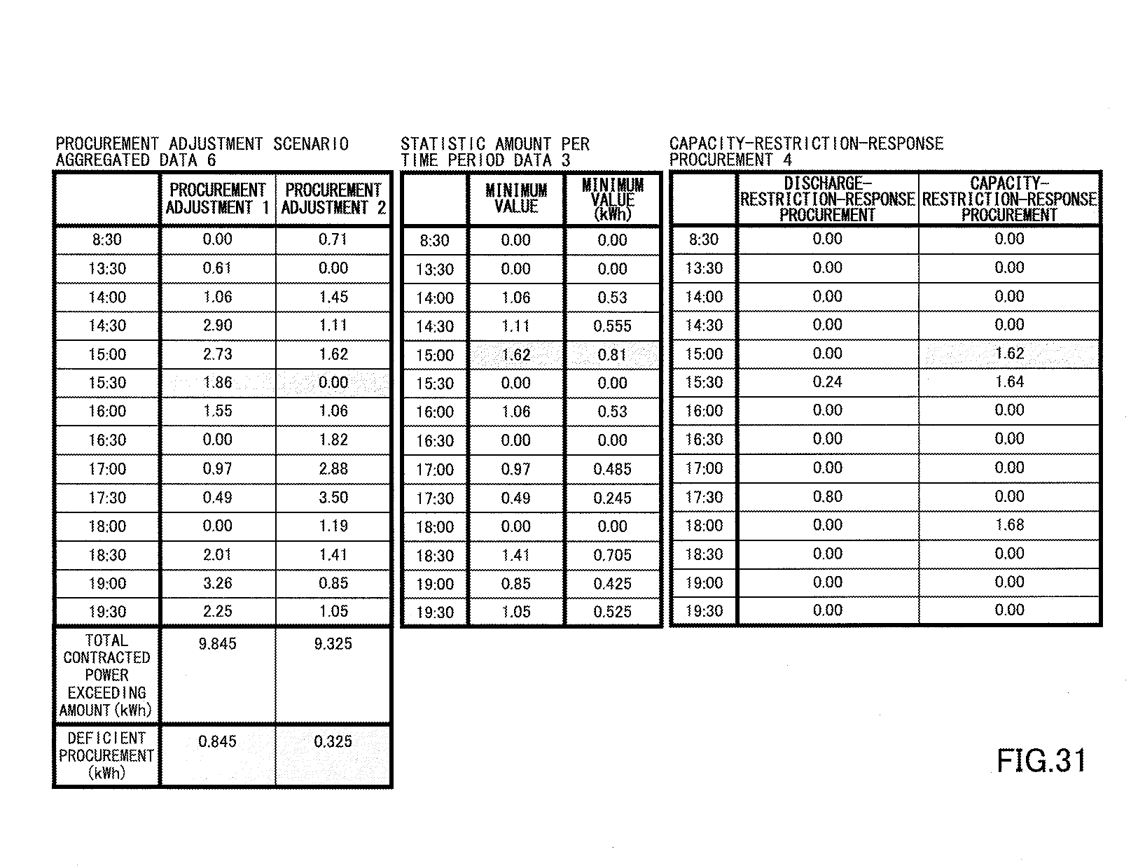

FIGS. 30 through 33 are diagrams of examples in which the process illustrated in the flowchart of FIG. 24 is repeated. In FIG. 30, the deficient procurement amounts are calculated with respect to the procurement adjustment scenarios, and as a result, the capacity restriction is violated (procurement adjustment scenario aggregated data 5). Then, the minimum value and the expectation value of the contracted power exceeding amounts in each unit time of the procurement adjustment scenarios are calculated (only kW of minimum value and power amount value of 30 minutes). Not all of the minimum contracted power exceeding amounts of the time periods are zero, and therefore 15:00, which corresponds to the maximum one of the minimum contracted power exceeding amounts, is selected (statistic amount per time period data 2). The maximum one of the minimum contracted power exceeding amounts is less than the maximum deficient procurement amount (0.82 kWh<1.665 kWh), and therefore the capacity-restriction-response procurement amount of 15:30 is updated by the maximum one of the minimum contracted power exceeding amounts (1.64 kW). The updated result is indicated in the table on the far right (capacity-restriction-response procurement 3). Then, the updated capacity-restriction-response procurement amount is applied to the procurement adjustment scenarios (procurement adjustment scenario 1 at 15:30: 3.5-1.64=1.86, procurement adjustment scenario 2 at 15:30: 1.64-1.64=0.00) (see FIG. 31).

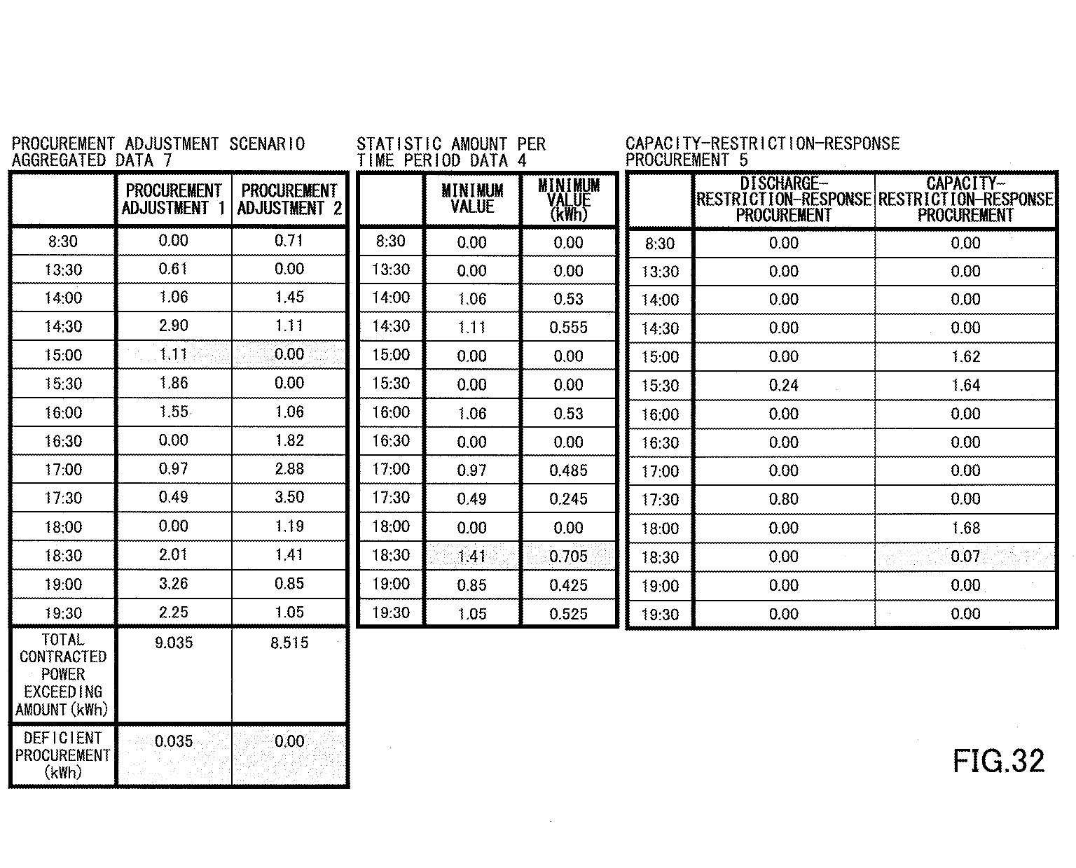

In FIG. 31, the deficient procurement amounts of the procurement adjustment scenarios are not zero and the capacity restriction violation is not resolved (procurement adjustment scenario aggregated data 6), and therefore the minimum value and the expectation value of the contracted power exceeding amounts in each time period are calculated (only kW of minimum value and power amount value of 30 minutes). Not all of the minimum contracted power exceeding amounts of the time periods are zero, and therefore 15:00, which corresponds to the maximum one of the minimum contracted power exceeding amounts, is selected (statistic amount per time period data 3). The maximum one of the minimum contracted power exceeding amounts (0.81 kWh) is less than the maximum deficient procurement amount (0.84 kWh), and therefore the capacity-restriction-response procurement amount of 15:00 is updated by the maximum one of the minimum contracted power exceeding amounts (1.62 kW). The updated result is indicated in the table on the far right (capacity-restriction-response procurement 4). Then, the updated capacity-restriction-response procurement amount is applied to the procurement adjustment scenarios (procurement adjustment scenario 1 at 15:00: 2.73-1.62=1.11, procurement adjustment scenario 2 at 15:00: 1.62-1.62=0.00) (see FIG. 32).

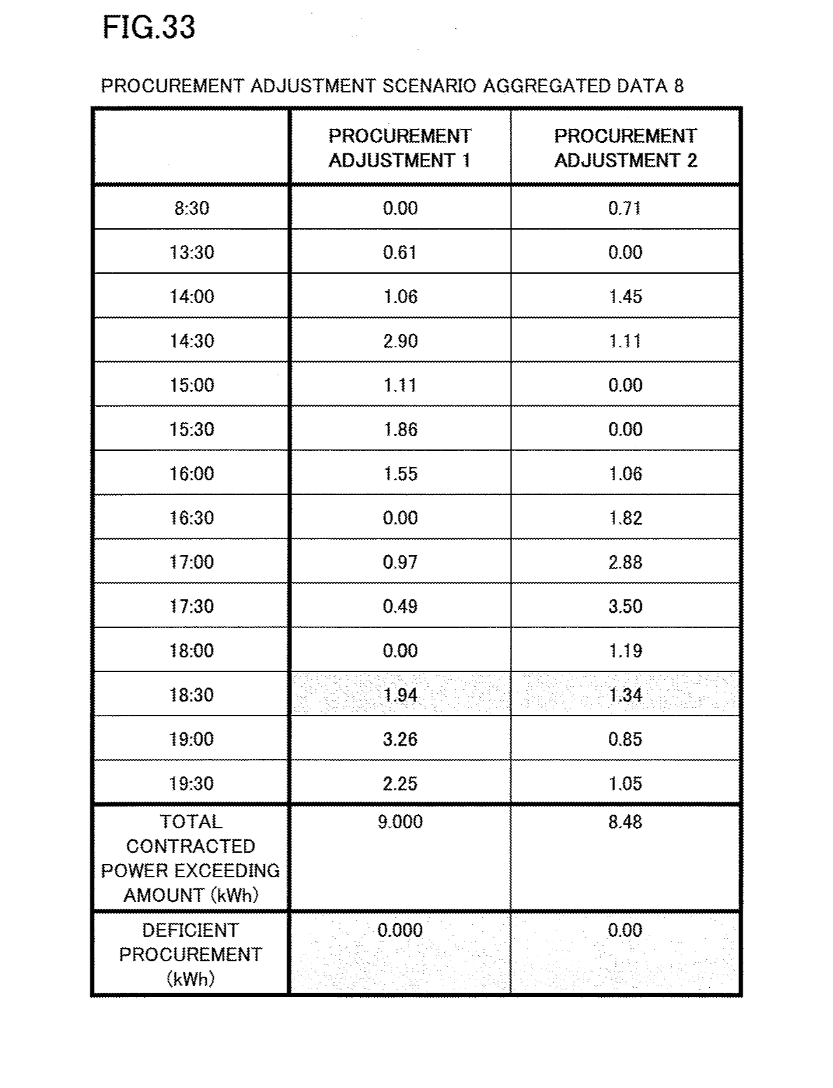

In FIG. 32, the deficient procurement amount of the procurement adjustment scenario 2 has become zero, but the deficient procurement amount is not zero in scenario 1 and an evaluation is made that the capacity restriction is violated (procurement adjustment scenario aggregated data 7), and therefore the minimum value and the expectation value of the contracted power exceeding amounts in each time period are calculated (only kW of minimum value and power amount value of 30 minutes). Not all of the minimum contracted power exceeding amounts of the time periods are zero, and therefore 18:30, which corresponds to the maximum one of the minimum contracted power exceeding amounts, is selected (statistic amount per time period data 4). The maximum one of the minimum contracted power exceeding amounts (0.71 kWh) is less than the maximum deficient procurement amount (0.035 kWh), and therefore the capacity restriction violation will be resolved by procuring only the maximum deficient procurement amount. Accordingly, the capacity-restriction-response procurement amount of 18:30 is updated by the maximum deficient procurement amount (0.07 kW). The updated result is indicated in the table on the far right (capacity-restriction-response procurement 5). Then, the updated capacity-restriction-response procurement amount is applied to the procurement adjustment scenarios (procurement adjustment scenario 1 at 18:30: 2.01-0.07=1.94, procurement adjustment scenario 2 at 18:30: 1.41-0.07=1.34) (see FIG. 33).

In FIG. 33, the deficient procurement amount of the procurement adjustment scenarios is zero in all scenarios (procurement adjustment scenario aggregated data 8), and therefore the capacity restriction violation is resolved, and the process is ended. As a result, a discharge-restriction-response procurement scenario and a capacity-restriction-response procurement scenario are output.

### [Procurement Plan Outputting Unit 13]

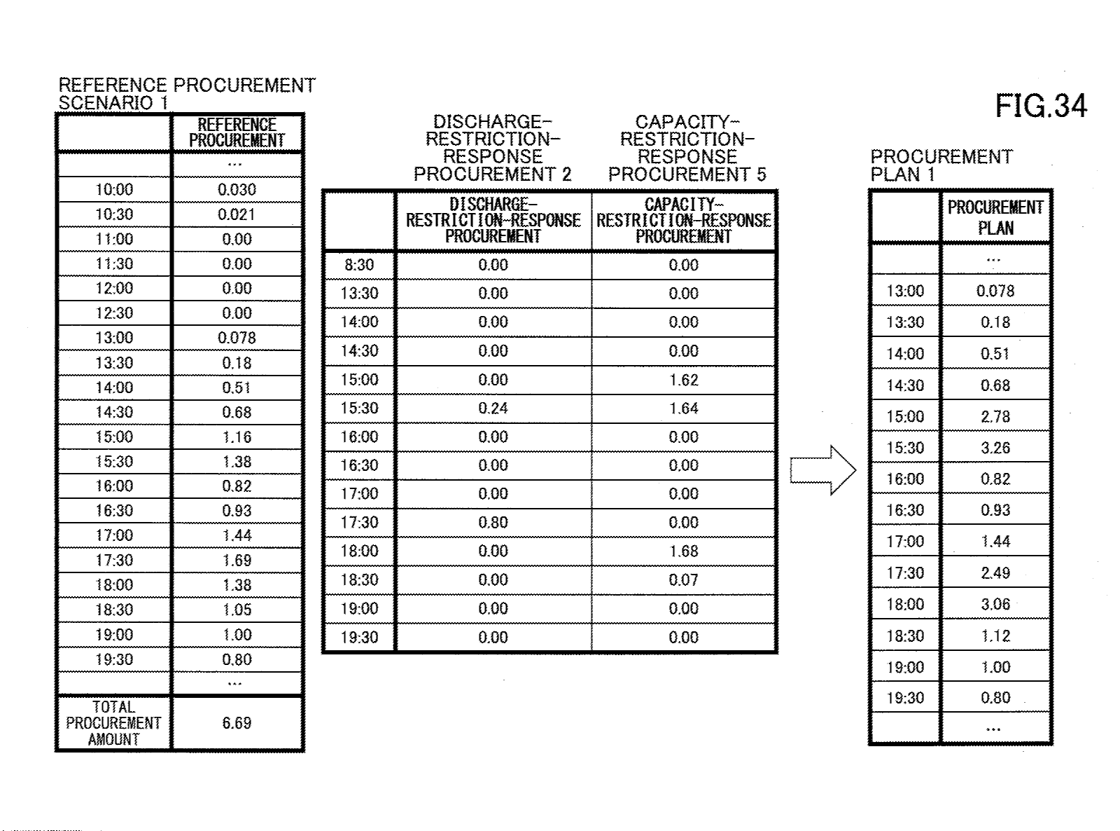

The procurement plan outputting unit 13 receives input of a reference procurement scenario, a discharge-restriction-response procurement scenario, and a capacity-restriction-response procurement scenario. The procurement plan outputting unit 13 obtains the sum of the values of the time periods in which the data is updated in the discharge-restriction-response procurement scenario and the capacity-restriction-response procurement scenario, and outputs the results as a procurement plan. FIG. 34 is a diagram illustrating an example of a procurement plan.

### <Overview>

As described above, according to the present embodiment, when minimizing the preliminary procurement plan with respect to a plurality of scenarios in consideration of forecast errors, it is possible to create a procurement plan within a sufficiently short time, even when many restriction conditions are set.

That is, the creation of a procurement plan according to the present embodiment does not involve solving an optimization problem by spending a high calculation cost based on restriction conditions set for each unit time in a plurality of scenarios, or solving an optimization problem with respect to the individual scenarios. In the present embodiment, individual procurement scenarios are calculated by a simple process of allocating the power storage amount within the restriction range of the storage battery. Then, based on the individual procurement scenarios, a reference procurement plan is created, which satisfies the restriction condition in a majority of the scenarios. Adjustments are made such that the reference procurement scenario satisfies the restriction condition. This adjustment is only limited to the procurement adjustment scenarios that do not satisfy the restriction condition by the reference procurement scenario. Accordingly, a minimum procurement plan may be created while suppressing the calculation cost.

According to an aspect of the embodiments, it is possible to create a procurement plan within a sufficiently short time.

Preferred embodiments of the present invention have been described in above; however, the present invention is not limited to the specific embodiments described herein, and a variety of modifications and changes may be made without departing from the scope of the present invention. That is, the present invention is not to be construed as limited by the details of the examples and attached drawings.

The procurement scenario is an example of “procurement time-series data”. The procurement adjustment scenario is an example of “procurement adjustment time-series data”. The applicable scenario is an example of “applicable time-series data”. The reference procurement scenario is an example of “reference procurement time-series data”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an electric power procurement adjustment program that causes a computer to execute a process, the process comprising:
generating a plurality of applicable time-series data items by excluding procurement time-series data items indicating a large total procurement amount from a plurality of procurement time-series data items defining a power amount to be procured from outside at every predetermined time;
generating reference procurement time-series data to be used as a reference of adjustment, based on an expectation value in each time period in the plurality of applicable time-series data items; and
comparing the plurality of applicable time-series data items with the reference procurement time-series data, extracting one or more of the plurality of applicable time-series data items having a larger total procurement amount than a total procurement amount of the reference procurement time-series data, and generating procurement adjustment time-series data, which is a target of the adjustment, based on the extracted one or more of the plurality of applicable time-series data items.

2. The non-transitory computer-readable recording medium according to claim 1, wherein the generating of the reference procurement time-series data includes calculating an average value of procurement amounts in the plurality of applicable time-series data items for each time period, and associating each time period with the average value to generate the reference procurement time-series data.

3. The non-transitory computer-readable recording medium according to claim 1, wherein the extracting of the one or more of the plurality of applicable time-series data items and the generating of the procurement adjustment time-series data includes comparing a total procurement amount of each of the plurality of applicable time-series data items with the total procurement amount of the reference procurement time-series data, extracting the one or more of the plurality of applicable time-series data items having a larger total procurement amount than the total procurement amount of the reference procurement time-series data, and generating the procurement adjustment time-series data based on the extracted one or more of the plurality of applicable time-series data items.

4. The non-transitory computer-readable recording medium according to claim 1, the process further comprising:
extracting a time period to be a target of the adjustment from the procurement adjustment time-series data;
making the adjustment on the procurement adjustment time-series data with respect to the extracted time period, based on a discharge restriction according to a discharge amount per unit time of a storage battery;
making the adjustment on the adjusted procurement adjustment time-series data based on a capacity restriction according to an accumulative discharge amount of the storage battery; and
outputting procurement plan time-series data defining a power amount to be actually procured from outside at every predetermined time, based on results of the adjustments.

5. The non-transitory computer-readable recording medium according to claim 4, wherein
the extracting of the time period to be the target of the adjustment from the procurement adjustment time-series data includes
subtracting the reference procurement time-series data and an adjustable demand amount from a value of each time period in net demand time-series data corresponding to the procurement adjustment time-series data,
comparing a result of the subtraction with contracted power to calculate a contracted power exceeding amount, and updating the procurement adjustment time-series data by the contracted power exceeding amounts, and
deleting a time period in which a maximum value of the contracted power exceeding amounts is zero, from the time periods of the updated procurement adjustment time-series data.

6. The non-transitory computer-readable recording medium according to claim 5, wherein
the making of the adjustment based on the discharge restriction includes
calculating a discharge restriction exceeding amount exceeding the discharge restriction based on the procurement adjustment time-series data,
updating discharge-restriction-response procurement time-series data by a maximum value of the calculated discharge restriction exceeding amount, and
subtracting a value of the updated discharge-restriction-response procurement time-series data from the procurement adjustment time-series data.

7. The non-transitory computer-readable recording medium according to claim 6, wherein
the making of the adjustment based on the capacity restriction includes
selecting a time period in which a minimum value of the contracted power exceeding amounts is maximum, from the time periods of the updated procurement adjustment time-series data,
updating capacity-restriction-response procurement time-series data by the maximum one of the minimum value, when the maximum one of the minimum value is less than a value of a deficient procurement,
updating the capacity-restriction-response procurement time-series data by the value of the deficient procurement, when the maximum one of the minimum value is not less than the value of the deficient procurement, and
repeating the adjustment based on the capacity restriction until a capacity restriction violation is resolved.

8. The non-transitory computer-readable recording medium according to claim 7, wherein
the outputting of the procurement plan time-series data includes
obtaining a sum of values in time periods in which data is updated in the discharge-restriction-response procurement time-series data and in the capacity-restriction-response procurement time-series data, and outputting the obtained sum as the procurement plan time-series data.

9. An electric power procurement adjustment apparatus comprising:
a processor configured to execute a process including
generating a plurality of applicable time-series data items by excluding procurement time-series data items indicating a large total procurement amount from a plurality of procurement time-series data items defining a power amount to be procured from outside at every predetermined time,
generating reference procurement time-series data to be used as a reference of adjustment, based on an expectation value in each time period in the plurality of applicable time-series data items, and
comparing the plurality of applicable time-series data items with the reference procurement time-series data, extracting one or more of the plurality of applicable time-series data items having a larger total procurement amount than a total procurement amount of the reference procurement time-series data, and generating procurement adjustment time-series data, which is a target of the adjustment, based on the extracted one or more of the plurality of applicable time-series data items.

10. The electric power procurement adjustment apparatus according to claim 9, wherein the generating of the reference procurement time-series data includes calculating an average value of procurement amounts in the plurality of applicable time-series data items for each time period, and associating each time period with the average value to generate the reference procurement time-series data.

11. The electric power procurement adjustment apparatus according to claim 9, wherein the extracting of the one or more of the plurality of applicable time-series data items and the generating of the procurement adjustment time-series data includes comparing a total procurement amount of each of the plurality of applicable time-series data items with the total procurement amount of the reference procurement time-series data, extracting the one or more of the plurality of applicable time-series data items having a larger total procurement amount than the total procurement amount of the reference procurement time-series data, and generating the procurement adjustment time-series data based on the extracted one or more of the plurality of applicable time-series data items.

12. The electric power procurement adjustment apparatus according to claim 9, the process further including
extracting a time period to be a target of the adjustment from the procurement adjustment time-series data,
making the adjustment on the procurement adjustment time-series data with respect to the extracted time period, based on a discharge restriction according to a discharge amount per unit time of a storage battery,
making the adjustment on the adjusted procurement adjustment time-series data based on a capacity restriction according to an accumulative discharge amount of the storage battery, and
outputting procurement plan time-series data defining a power amount to be actually procured from outside at every predetermined time, based on results of the adjustments.

13. The electric power procurement adjustment apparatus according to claim 12, wherein
the extracting of the time period to be the target of the adjustment from the procurement adjustment time-series data includes
subtracting the reference procurement time-series data and an adjustable demand amount from a value of each time period in net demand time-series data corresponding to the procurement adjustment time-series data,
comparing a result of the subtraction with contracted power to calculate a contracted power exceeding amount, and updating the procurement adjustment time-series data by the contracted power exceeding amounts, and
deleting a time period in which a maximum value of the contracted power exceeding amounts is zero, from the time periods of the updated procurement adjustment time-series data.

14. The electric power procurement adjustment apparatus according to claim 13, wherein
the making of the adjustment based on the discharge restriction includes
calculating a discharge restriction exceeding amount exceeding the discharge restriction based on the procurement adjustment time-series data,
updating discharge-restriction-response procurement time-series data by a maximum value of the calculated discharge restriction exceeding amount, and
subtracting a value of the updated discharge-restriction-response procurement time-series data from the procurement adjustment time-series data.

15. The electric power procurement adjustment apparatus according to claim 14, wherein
the making of the adjustment based on the capacity restriction includes
selecting a time period in which a minimum value of the contracted power exceeding amounts is maximum, from the time periods of the updated procurement adjustment time-series data,
updating capacity-restriction-response procurement time-series data by the maximum one of the minimum value, when the maximum one of the minimum value is less than a value of a deficient procurement,
updating the capacity-restriction-response procurement time-series data by the value of the deficient procurement, when the maximum one of the minimum value is not less than the value of the deficient procurement, and
repeating the adjustment based on the capacity restriction until a capacity restriction violation is resolved.

16. The electric power procurement adjustment apparatus according to claim 15, wherein
the outputting of the procurement plan time-series data includes
obtaining a sum of values in time periods in which data is updated in the discharge-restriction-response procurement time-series data and in the capacity-restriction-response procurement time-series data, and outputting the obtained sum as the procurement plan time-series data.

17. An electric power procurement adjustment method executed by a computer, the electric power procurement adjustment method comprising:
generating a plurality of applicable time-series data items by excluding procurement time-series data items indicating a large total procurement amount from a plurality of procurement time-series data items defining a power amount to be procured from outside at every predetermined time;
generating reference procurement time-series data to be used as a reference of adjustment, based on an expectation value in each time period in the plurality of applicable time-series data items; and
comparing the plurality of applicable time-series data items with the reference procurement time-series data, extracting one or more of the plurality of applicable time-series data items having a larger total procurement amount than a total procurement amount of the reference procurement time-series data, and generating procurement adjustment time-series data, which is a target of the adjustment, based on the extracted one or more of the plurality of applicable time-series data items.

18. The electric power procurement adjustment method according to claim 17, wherein the generating of the reference procurement time-series data includes calculating an average value of procurement amounts in the plurality of applicable time-series data items for each time period, and associating each time period with the average value to generate the reference procurement time-series data.

19. The electric power procurement adjustment method according to claim 17, wherein the extracting of the one or more of the plurality of applicable time-series data items and the generating of the procurement adjustment time-series data includes comparing a total procurement amount of each of the plurality of applicable time-series data items with the total procurement amount of the reference procurement time-series data, extracting the one or more of the plurality of applicable time-series data items having a larger total procurement amount than the total procurement amount of the reference procurement time-series data, and generating the procurement adjustment time-series data based on the extracted one or more of the plurality of applicable time-series data items.

20. The electric power procurement adjustment method according to claim 17, the electric power procurement adjustment method further comprising:
extracting a time period to be a target of the adjustment from the procurement adjustment time-series data;
making the adjustment on the procurement adjustment time-series data with respect to the extracted time period, based on a discharge restriction according to a discharge amount per unit time of a storage battery;
making the adjustment on the adjusted procurement adjustment time-series data based on a capacity restriction according to an accumulative discharge amount of the storage battery; and
outputting procurement plan time-series data defining a power amount to be actually procured from outside at every predetermined time, based on results of the adjustments.

21. The electric power procurement adjustment method according to claim 20, wherein
the extracting of the time period to be the target of the adjustment from the procurement adjustment time-series data includes
subtracting the reference procurement time-series data and an adjustable demand amount from a value of each time period in net demand time-series data corresponding to the procurement adjustment time-series data,
comparing a result of the subtraction with contracted power to calculate a contracted power exceeding amount, and updating the procurement adjustment time-series data by the contracted power exceeding amounts, and
deleting a time period in which a maximum value of the contracted power exceeding amounts is zero, from the time periods of the updated procurement adjustment time-series data.

22. The electric power procurement adjustment method according to claim 21, wherein
the making of the adjustment based on the discharge restriction includes
calculating a discharge restriction exceeding amount exceeding the discharge restriction based on the procurement adjustment time-series data,
updating discharge-restriction-response procurement time-series data by a maximum value of the calculated discharge restriction exceeding amount, and
subtracting a value of the updated discharge-restriction-response procurement time-series data from the procurement adjustment time-series data.

23. The electric power procurement adjustment method according to claim 22, wherein
the making of the adjustment based on the capacity restriction includes
selecting a time period in which a minimum value of the contracted power exceeding amounts is maximum, from the time periods of the updated procurement adjustment time-series data,
updating capacity-restriction-response procurement time-series data by the maximum one of the minimum value, when the maximum one of the minimum value is less than a value of a deficient procurement,
updating the capacity-restriction-response procurement time-series data by the value of the deficient procurement, when the maximum one of the minimum value is not less than the value of the deficient procurement, and
repeating the adjustment based on the capacity restriction until a capacity restriction violation is resolved.

24. The electric power procurement adjustment method according to claim 23, wherein
the outputting of the procurement plan time-series data includes
obtaining a sum of values in time periods in which data is updated in the discharge-restriction-response procurement time-series data and in the capacity-restriction-response procurement time-series data, and outputting the obtained sum as the procurement plan time-series data.
